(19) United States
(12) Patent Application Publication
(10) Pub. No.: US 2015/0213213 A1
(43) Pub. Date: Jul. 30, 2015

(54) Method and System for Engagement, Logistics, and Technology for Health Services

(71) Applicant: Health: ELT, LLC, Dallas, TX (US)

(72) Inventors: L. Cade Havard, Dallas, TX (US); Amanda Meredith Havard, Dallas, TX (US); Doug Havard, Dallas, TX (US)

(73) Assignee: Health: ELT, LLC, Dalllas, TX (US)

(21) Appl. No.: 14/588,661

(22) Filed: Jan. 2, 2015

Related U.S. Application Data
(60) Provisional application No. 61/923,266, filed on Jan. 3, 2014.

(51) Int. Cl. G06F 19/00

(52) U.S. Cl. CPC G06F 19/3406; G06F 19/363; G06F 19/322

(57) ABSTRACT

A system and method to improve health care quality and/or reduce costs of providing health benefits includes collecting data about individuals receiving the health benefits through engagement with the individuals to collect data using an app executing on a mobile device, collecting data regarding logistics for delivery of the health benefits using the app executing on the mobile device, and managing the delivery of the health benefits from a remote location using a dashboard software application in operative communication with the app executing on the mobile device.

### CROSS REFERENCE TO RELATED APPLICATIONS

This application claims priority under 35 U.S.C. §119 to a provisional application Ser. No. 61/923,266 filed on Jan. 3, 2014 and which is hereby incorporated by reference in its entirety.

### FIELD OF THE INVENTION

The present invention relates to health care. More particularly, but not exclusively, the present invention relates to engagement, logistics, and technology associated with health care in order to offer improved health care quality and/or reduce costs of providing health care benefits.

### BACKGROUND OF THE INVENTION

Much inefficiency exists in the health care system. However, it is difficult to identify and eliminate inefficiencies due to the nature of health care. Although it is generally recognized that technology can be used to help eliminate inefficiencies, inefficiencies remain. In fact, various attempts to use technology to eliminate inefficiencies may very well have the opposite effect and lead to more costly care and more complicated care.

In health care numerous different entities are involved in various ways. These entities may include health care providers, health care insurers, government entities, etc. Each of these different entities may collect or store different types of data of in one form or another. These different data stores or silos are generally independent. Information collected may not even be used by the entity collecting the data, information collected may not be shared by the entity collecting the data, and if the information is ultimately shared it may not be shared in a timely manner or in a way that allows it to impact quality of health care or to positively impact the administration of health care.

What is needed are ways to improve health care using technology.

### SUMMARY OF THE INVENTION

Therefore, it is a primary object, feature, or advantage of the present invention to improve over the state of the art.

It is a further object, feature, or advantage of the present invention to eliminate inefficiencies in administration of health care.

It is a still further object, feature, or advantage of the present invention to improve the quality of health care.

A still further object, feature, or advantage of the present invention is to reduce health care costs.

Another object, feature, or advantage of the present invention is to provide for timely and accurate reporting of services provided.

Yet another object, feature, or advantage of the present invention it to analyze claims data to make recommendations such as recommendations to improve the delivery of health care services.

Another object, feature, or advantage of the present invention is to streamline data collection.

A still further object, feature, or advantage of the present invention is the ability to better allocate and utilize resources used in the delivery of health care services.

Another object, feature, or advantage of the present invention is to collect and analyze data that can lead to prevention or early treatment of health conditions.

Yet another object, feature, or advantage of the present invention is to avoid health care fraud, waste, and abuses.

A further object, feature, or advantage of the present invention is to provide administrators of health services with real-time information about the delivery of health care services.

A still further object, feature, or advantage of the present invention is to provide systems that allow for administrators of health services to use real-time information to effectively manage the delivery of health care services.

Another object, feature, or advantage of the present invention is to protect against fraudulent claims of abuse made against workers delivering health care services.

Yet another object, feature, or advantage of the present invention it to improve safety of field workers.

A still further object, feature, or advantage of the present invention is to provide audio and video feeds of emergency situations.

One or more of these objects, features, or advantages will become clear from the description and claims that follow. Although various objects, features, or advantages are described herein, it is to be understood that the present invention is not to be limited by or to these objects, features, or advantages. It is to be further understood that no single embodiment need exhibit each or every one of these objects, features, or advantages as different embodiments may have different objects, features, or advantages.

According to one aspect, a method is provided to improve health care quality and/or reduce costs of providing health benefits. The method includes collecting data about individuals receiving the health benefits through engagement with the individuals to collect data using a software application (an “app”) executing on a mobile device, collecting data regarding logistics for delivery of the health benefits using the app executing on the mobile device, and managing the delivery of the health benefits from a remote location using a dashboard software application in operative communication with the app executing on the mobile device.

According to another aspect, a method to improve health care quality and/or reduce costs of providing health benefits includes providing a database stored on a non-transitory computer readable medium, and providing a field worker mobile app for use on a mobile device by field workers, the field worker mobile app having a field worker interface, the field worker interface configured to collect data about interactions with individuals receiving the health benefits, the field worker mobile app further configured to collect data about logistics associated with the delivery of the health benefits, and the field worker mobile app further configured to communicate data collected through the field worker mobile app to the database. The method further includes collecting the data collected through the field worker mobile app at the database, sending job data to the field worker mobile app, and collecting logistics data at the database.

According to another aspect, a system for improving health care quality and/or reducing costs of providing health benefits includes one or more mobile apps for data collection and data access for individuals associated with data collection, wherein each of the mobile apps is tailored to job functions of the individuals associated with the data collection and provides for sending and receiving communications with a server. The system further includes a central database storing data collected by the one or more mobile apps and data from additional data sources and a software application executing on a computing device, the software application configured to access the central database and allow an administrator to send data to the one or more mobile apps.

According to another aspect, a method for providing emergency functionality using a mobile app executing on a mobile device is provided. The method includes receiving an input from the user of the mobile device indicative of an emergency situation and upon receiving the input from the user, streaming audio and/or visual information from the mobile device to a remote location. The method may further include sending location information for the mobile device to the remote location and notifying emergency services of the location for the mobile device.

According to another aspect, a method to improve health care quality and/or reduce costs of providing health benefits may include collecting data about individuals receiving the health benefits through engagement with the individuals to collect data using an app executing on a mobile device, collecting data regarding logistics for delivery of the health benefits using the app executing on the mobile device, and managing the delivery of the health benefits from a remote location using a dashboard software application in real-time communication with the app executing on the mobile device. The data about individuals receiving the health benefits may include audio/visual information documenting conditions of the individuals and time and location information associated with the audio/visual information. The data regarding logistics may include time of arrival for care workers providing the benefits. The method may further include relating the time of arrival and the audio/visual information and associated time and location information.

### BRIEF DESCRIPTION OF THE DRAWINGS

FIG. 1 is a diagram illustrating a system formed by engagement, logistics, and technology.

FIG. 2 is a diagram illustrating a system in which one or more members or beneficiaries are present.

FIG. 3 is a diagram providing a more detailed example in the context of a managed Medicaid workflow.

FIG. 4 illustrates examples of app functions for a home health example.

FIG. 5 illustrates an example of a system, which includes a dashboard.

FIG. 6 illustrates a dashboard such as may be used by a managed care organization (MCO) or other health plan, home health agency, or other provider, or state or governmental oversight agency.

FIG. 7 illustrates another view of a dashboard with a zoomed in map view.

FIG. 8 illustrates another view of the dashboard.

FIG. 9 illustrates a view of a dashboard with a panel displaying information associated with a medical or supervisory worker in the field (field worker).

FIG. 10 illustrates an example of a dashboard showing a field worker who is en-route.

FIG. 11 illustrates an example of a dashboard of a field worker who is currently off-task.

FIG. 12 illustrates a dashboard for viewing members.

FIG. 13 illustrates a dashboard when viewing a member to whom a preauthorization number, or some other request or approval for care has been assigned (assigned member).

FIG. 14 illustrates a dashboard to illustrate functionality for searching for an unassigned member.

FIG. 15 illustrates a dashboard with a window present for checking eligibility of a member.

FIG. 16 illustrates a dashboard map view after eligibility has been confirmed.

FIG. 17 illustrates a dashboard for assigning a field worker.

FIGS. 18-23 illustrate various examples of a user interface for use by a field worker at the beginning of a task or visit.

FIG. 24 illustrates various screen displays relating to reviewing a plan before beginning a job.

FIG. 25 illustrates various screen displays relating to starting a session with a member and completing tasks.

FIG. 26 illustrates various screen displays relating to entering engagement data.

FIG. 27 illustrates a flow diagram showing initial processing of a member file.

FIG. 28 is a flow diagram illustrating further processing of a member file.

FIG. 29 is a flow diagram illustrating starting a member process.

FIG. 30 is a flow diagram illustrating finding members.

FIG. 31 is a flow diagram for scheduling visits.

FIGS. 32-34 are screen displays illustrating checking eligibility.

FIG. 35 illustrates an emergency panic button in a mobile app operating on a mobile device.

FIG. 36 is a flow chart associated with emergency functionality.

FIG. 37 is a flow chart associated with documenting patient condition at arrival time.

### DETAILED DESCRIPTION OF THE PREFERRED EMBODIMENTS

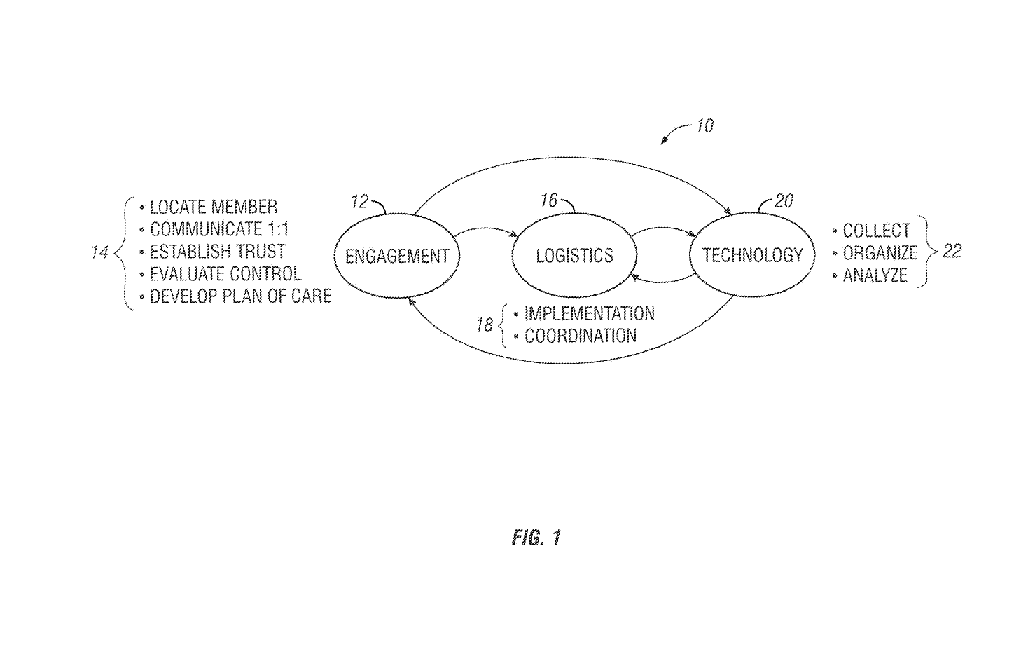

FIG. 1 illustrates a system 10 that is formed by engagement 12, logistics 16, technology 20, and the inter-relationships between these components.

Engagement is an important aspect of health care. The engagement component 12 includes an approach that engages individual members through personal outreach. Establishing a relationship with an individual member allows a proper strategy of care to be offered. Steps 14 in an engagement process may include locating a member, communicating one-on-one with the member, establishing trust with the member, evaluating the member's condition, and development a plan of care for the member.

The logistics component 16 is also a very important aspect of improved health care. The logistics process described herein provides a unique set of tools to turn coordination of care into a more streamlined, consistent, and effective process. Through using the logistics processes described herein improved implementation and coordination of care may be provided in areas such as Primary Care Physician (PCP) utilization, scheduling, Long Term Service and Support (LTSS)/Personal Attendant Services (PAS), assessment, Healthcare Effectiveness Data and Information Set (HEDIS) measures, prescription refills, case management, care plans, home health services of all types including skilled and non-skilled, patient education, lab work, and transportation.

The technology component 20 is a critical aspect of improved health care. Once the mechanism for gathering information is discovered through engagement and logistics, the collection results may be maximized through the process of collection, organization, and analysis. Information across the care continuum may be consistently collected. This consistent collection allows for gathering the same elements, in the same way, so they end up in the same place. Information may be collected through apps for devices such as tablets and smart phones, which allow for standardization and streamlined information collection. Both health data and evolving demographic information may be collected. Example of health data that may be collected includes assessment data of all types, member's current progress, real-time encounter data for early intervention, and HEDIS measures. The real-time encounter data for early intervention allows health care providers to instantly and securely share information in the form of notes, photos, or videos, via an app with case managers so that care becomes faster, more responsive, and ultimately better. This also allows for immediate documentation of the progression of wounds or symptoms or other changes. This documentation may serve other purposes such as to protect against fraudulent claims by being able to document patient condition at particular times including condition upon arrival of the worker. The HEDIS performance measures may be tracked when it is needed and the technology component allows the HEDIS measures to be completed and then reported instantaneously to facilitate tracking.

The collection of evolving demographic information allows for better engagement with members. Where members are transient, contact information often changes making them difficult to find. With access to centralized data, the most up-to-date and accurate contact information for each member may be monitored and aggregated. By identifying patterns in a member's life—from cell phone plans to relatives to where they receive government benefits, a sophisticated means for engaging members on an ongoing basis is provided. Demographic information from all relevant sources may be organized into a master database. That information may be aggregated to form a dataset with improved accuracy and completeness.

The collection of data further may allow for tracking of emergency room (ER) visits and hospitalizations as they occur, monitoring utilization of PCP, responding to member needs quickly, determining member satisfaction and improved retention.

In addition, the technology component 20 can provide for tailoring access to information for different parties in the care continuum so that everyone has what they need—and only what they need—in the most usable format. In addition, the technology component can assist in facilitating the use of data in real-time to improve the administration of health care related services.

By using the broader, more cohesive, and comprehensive data pool, the information may be analyzed for various purposes included to create more sophisticated predictive models. Analysis allows for identifying patterns that help one foresee the greatest unnecessary expenditures to contain the cost in the most catastrophic cases, forecast future costs, enable more accurate and thus more competitive pricing, indicate areas of duplication and waste, determine which vendors are the most cost effective, and identify members at risk for increased future needs.

Once information is collected, organized, and analyzed productive tools may be generated to coordinate all the pieces of member care and to improve member care while simultaneously being cost effective.

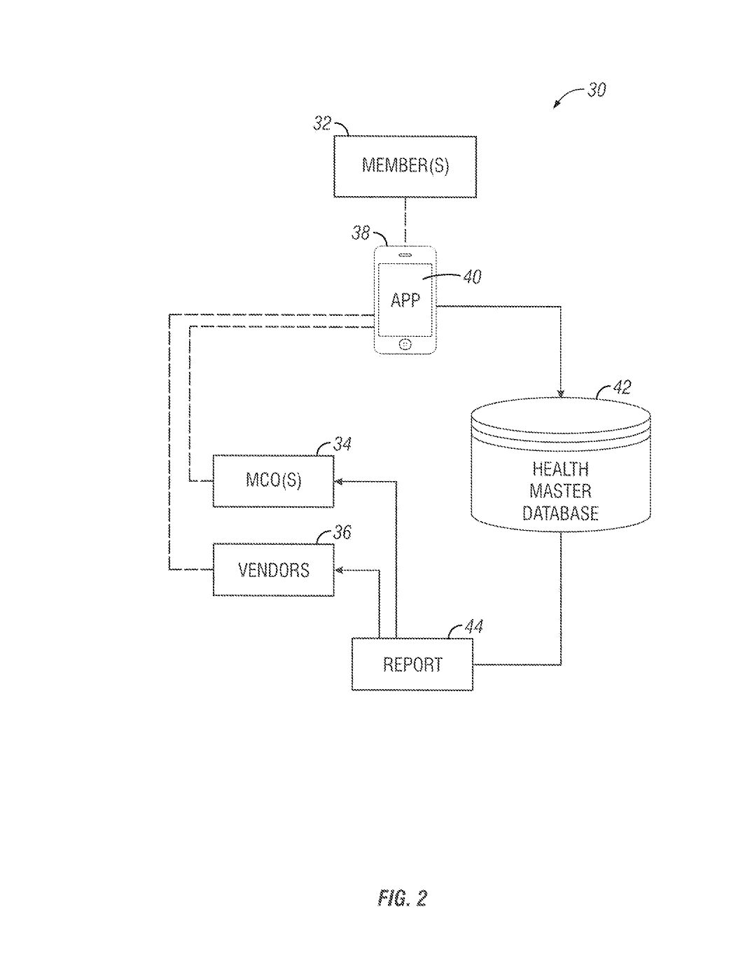

FIG. 2 is a diagram illustrating a system 30 in which one or more members 32 are present. One or more managed care organizations (MCO) 34 are also present along with one or more vendors 36. One or more apps 40 operating on a mobile device 38 are used by the MCO 34 and/or vendor 36 in engaging with the member 32. Information from the apps 40 is collected at the health master database 32. One or more reports 44 may be returned to the MCO 34 or vendor 36 based on information collected at the health master database 42.

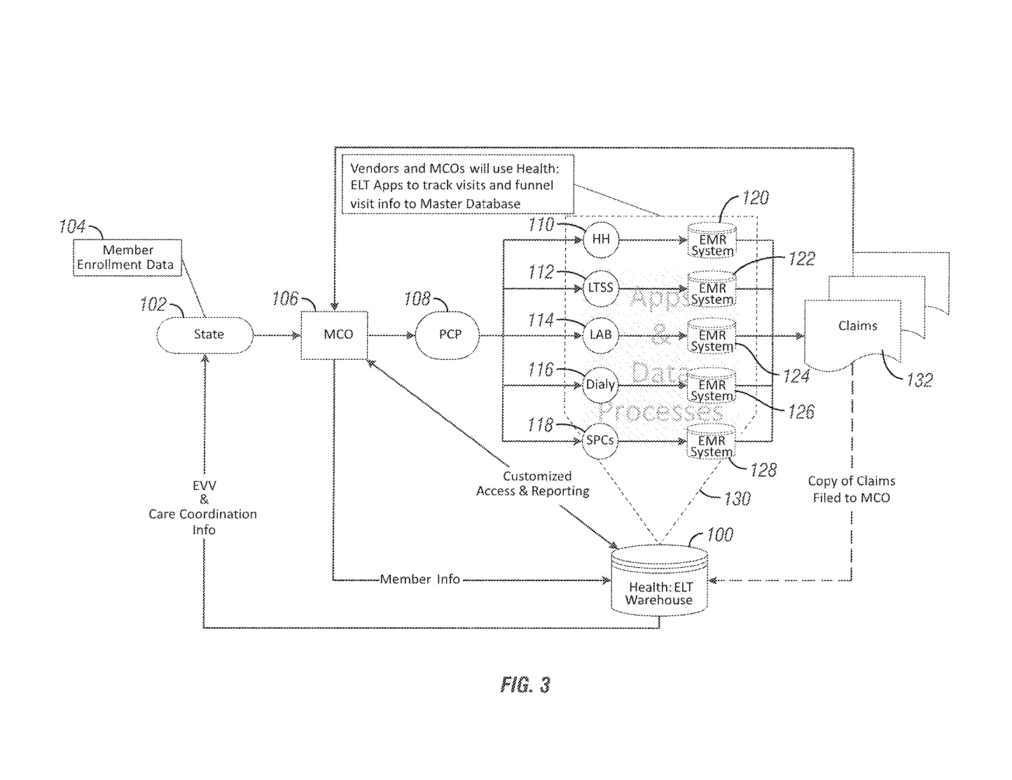

FIG. 3 is a diagram providing a more detailed example in the context of a managed Medicaid workflow. The system includes a master database 100. As shown in FIG. 3, a state 102 receives member enrollment data 104. The state 102 is in communication with a managed care organization 106. The managed care organization 106 provides member information to the health master database 100. The managed care organization 106 is in communication with a primary care provider (PCP) 108. The primary care provider is in communication with vendors such as home health (HH) 110, an LTSS 112, a LAB 114, a Daily 116, and Specialist Managed Care (SPCs) 118. Each of these vendors as well as the MCO 106 may use apps to track visits and funnel visit information to the master database 100. Each of these different providers has an associated claim system 120, 122, 124, 126, 128, all of which are used to produce claims 132. The claims 132 are communicated to the health master database 100. Customized access and reporting may be provided from the health master database 100 and to the managed care organization 106. In addition, electronic visit verification (EVV) and care coordination information from the health master database 100 may be provided to the state 102.

The customized access and reporting may include information such as services provided to a member, predictive cost estimates, HEDIS requirements and status, early intervention, duplication of services, visit confirmation, who did what to whom and when, prescription conflicts, email notifications, audio/visual evidence such as for wounds and conditions, real-time demographics on members, demographic patterns on members, LTSS needs and results, predictive modeling for assessments, service order modifications, tracking and confirmation of state mandates (e.g. EVV and care coordination), and real-time reporting of care provided.

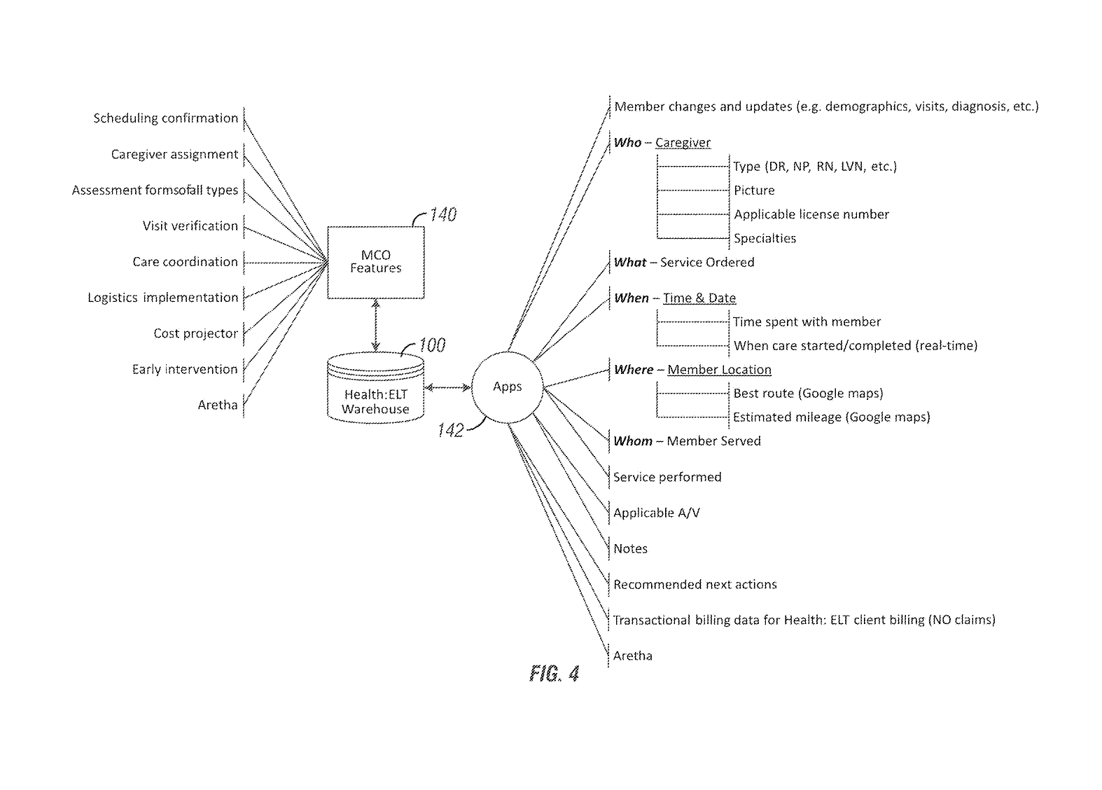

FIG. 4 illustrates examples of app functions for a home health example. In FIG. 4, the master database 100 is shown. MCO features 140 are also provided through communication with the master database 100. Apps 142 also electronically communicate with the master database 100. Examples of MCO features may include scheduling confirmation, caregiver assignment, assessment forms of all types, visit verification, care coordination, logistics implementation, a cost projector, early-intervention, and any number of other functions such as via dashboard access.

Examples of apps 142 may include member changes and updates (e.g. demographics, visits, diagnosis, etc.). This can include the “who” which provides details on the caregiver such as the type of care giver (doctor, nurse practitioner, registered nurse, LVN, etc.), a picture of the caregiver, an applicable license number for the caregiver, and specialties of the caregiver. Collected information can further include “what” in terms of services ordered, “when” in terms of a time and date including a time spent with the member and when care started and completed (this information may be collected in real-time), “where” in terms of the member location including a best route and an estimated mileage, “whom” in terms of the member server, the service performed, any applicable audio-visual recording, notes, recommended next actions, transactional billing data, and any number of other items.

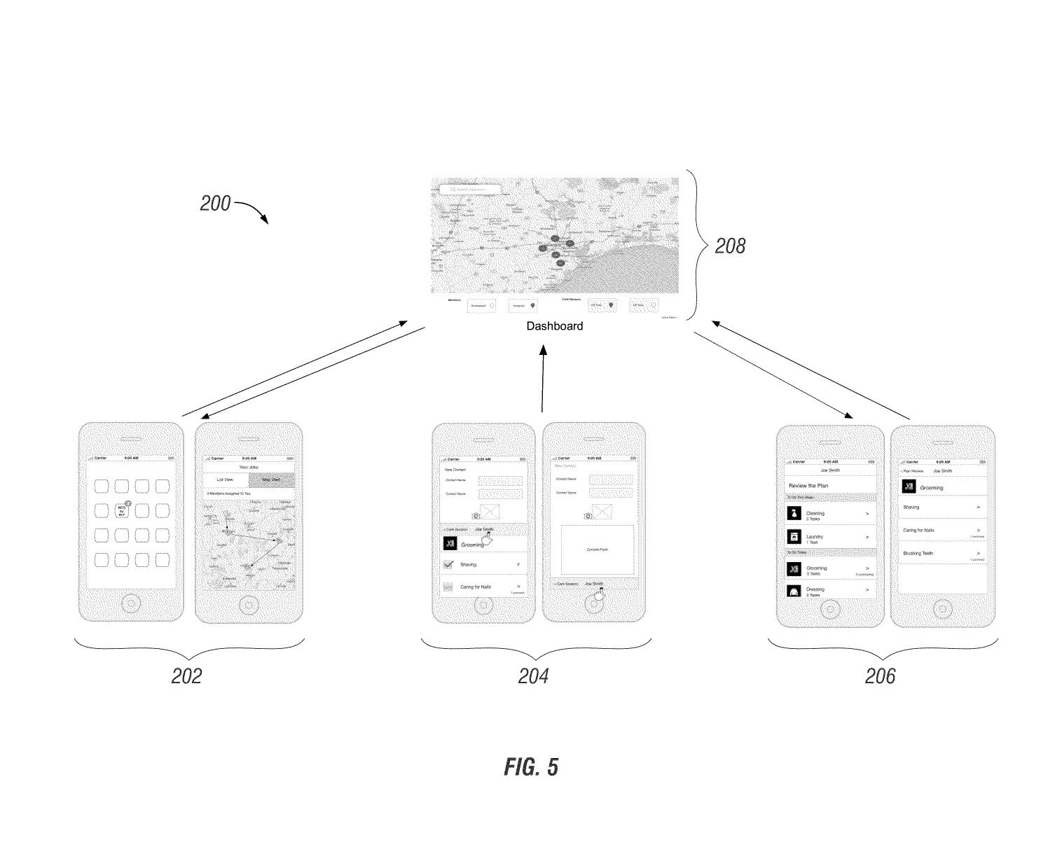

FIG. 5 illustrates an example of a system 200, which includes a dashboard 208. The dashboard is used to show information about both members and field workers. Also shown in FIG. 5, mobile app functions 202 allow for receiving wake-up, job instructions, routes, tasks, or checklists. Live timing data may be sent back to the dashboard. Mobile app functions 204 allow for collecting engagement data. Engagement data can include audio-visual information such as photos, videos, audio recordings of members and/or their environments in addition to textual information. Mobile app functions 206 allow for being organized. Tasks may be based on forms from PAS and LTSS. Thus, a visit may be structured according to a checklist. The entire visit as well as each task may be separately timed. Updates may be sent back and forth to the dashboard 208. Thus, the dashboard 208 may serve a variety of functions including verifying occurrence of visits, documenting tasks performed during visits, tracking the effectiveness of the field worker, and other functions. It is also important to understand that the dashboard 208 allows administrators to manage in real-time based upon data collected in real-time or other data. This is a significant benefit.

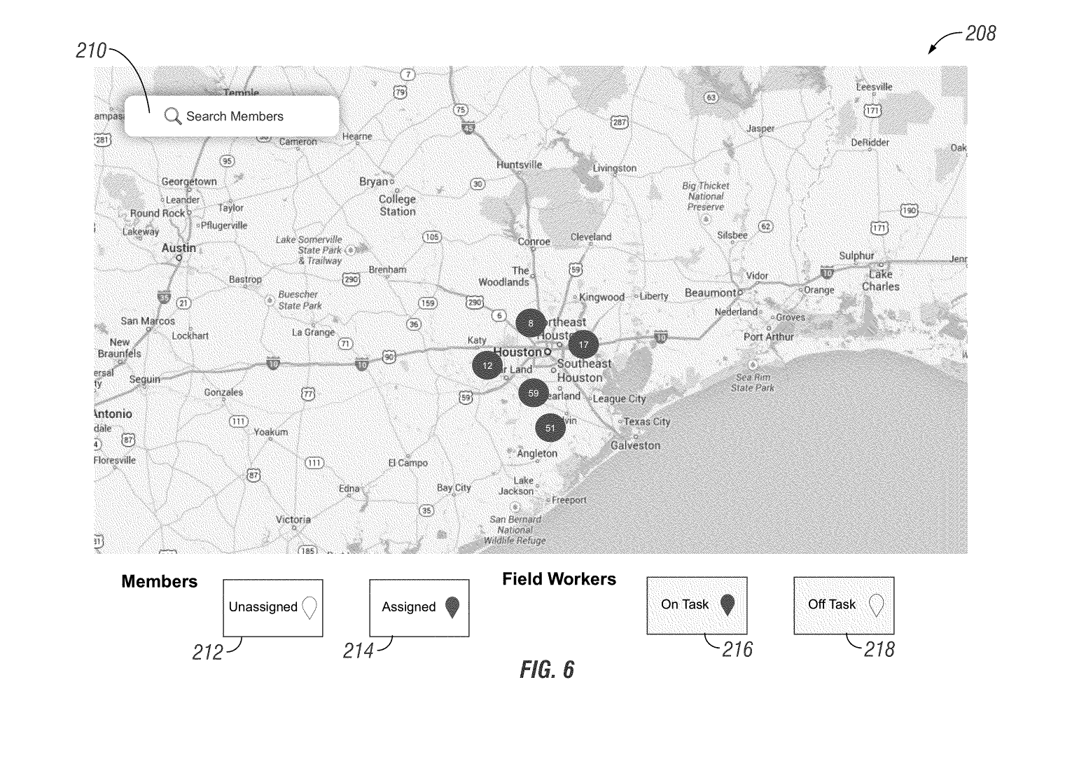

FIG. 6 illustrates a dashboard 208 such as may be used by an MCO or HHA. The dashboard 208 shows map with pins. The pins may be used to represent members and/or field workers and/or other caregivers and recipients. The appearance of the pins may be varied to indicate members who are unassigned 212, members who are assigned 214, field workers who are on task 216 or field workers who are off task 218 and therefore available to serve a client need. The pins may be used to represent a cluster of individual entities and a number may be placed on the pin to indicate the number of individuals within a particular cluster. A search box 210 is also shown, which may be used to locate particular members.

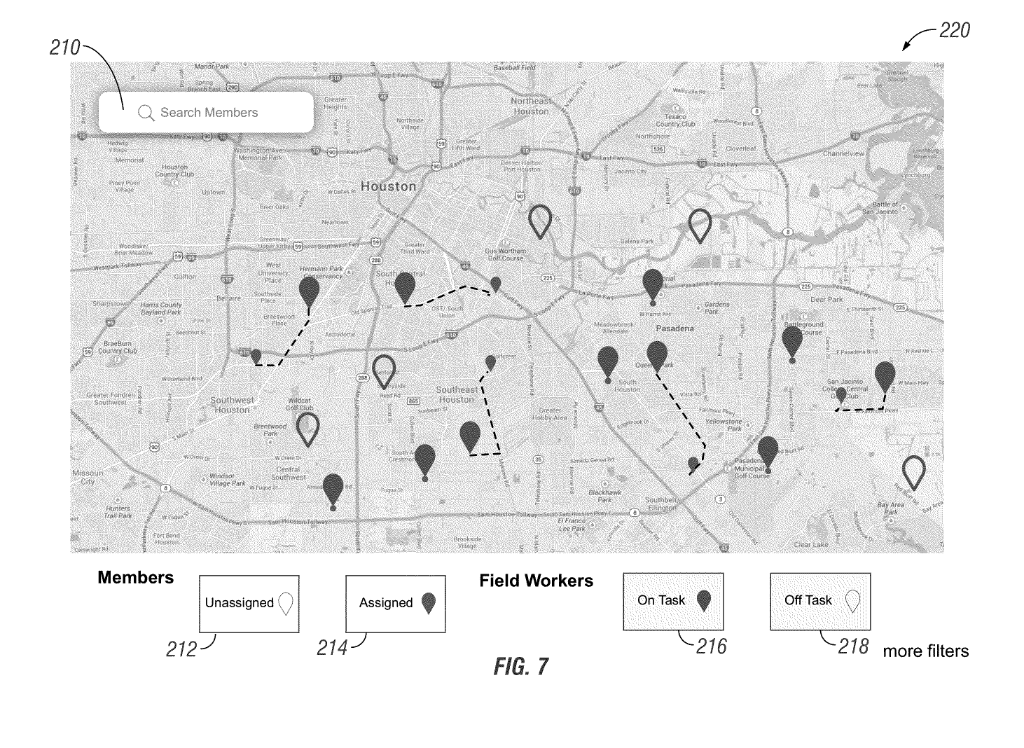

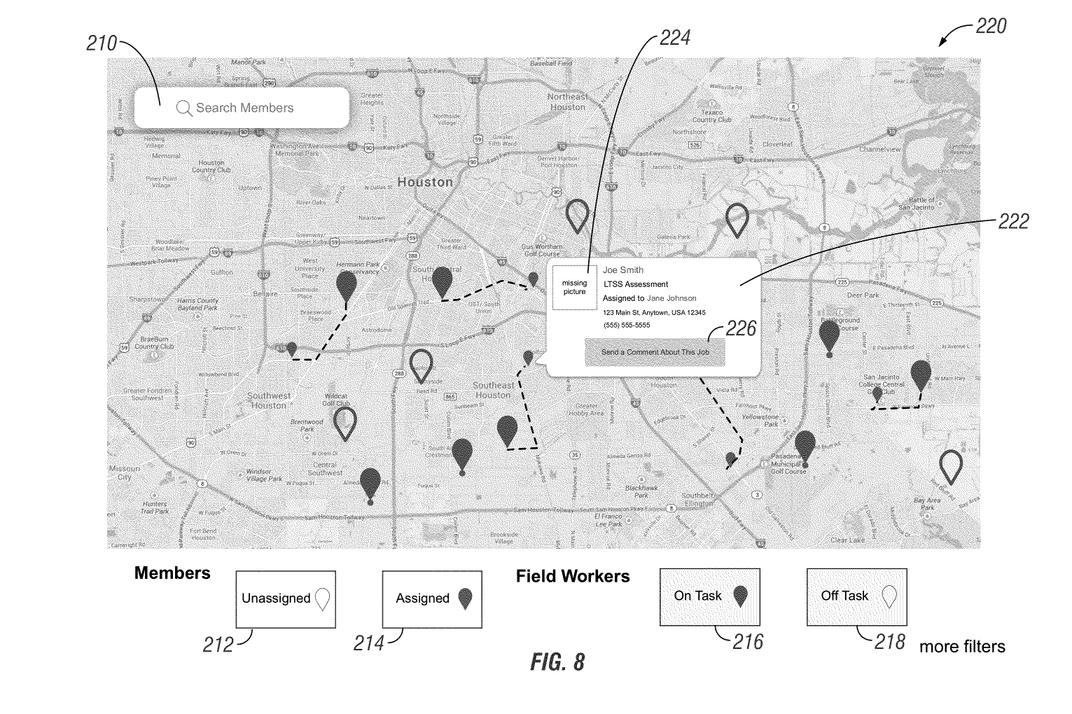

FIG. 7 illustrates another view of a dashboard 220 with a view zoomed in. A pin or marker may indicate that a field worker is onsite or in route with a suggested route provided. FIG. 8 illustrates another view of the dashboard 220. When a pin or marker associated with a member is selected a window 222 may be displayed, which may display information about the member. The window 222 shown is for a member and shows a job to perform regarding the member, who is assigned to perform the job, an address, and contact information. A photo 224 for the member may also be shown. A button 226 is also provided for sending comments about the job. A field worker may receive these comments when they arrive at the job and are reviewing the plan.

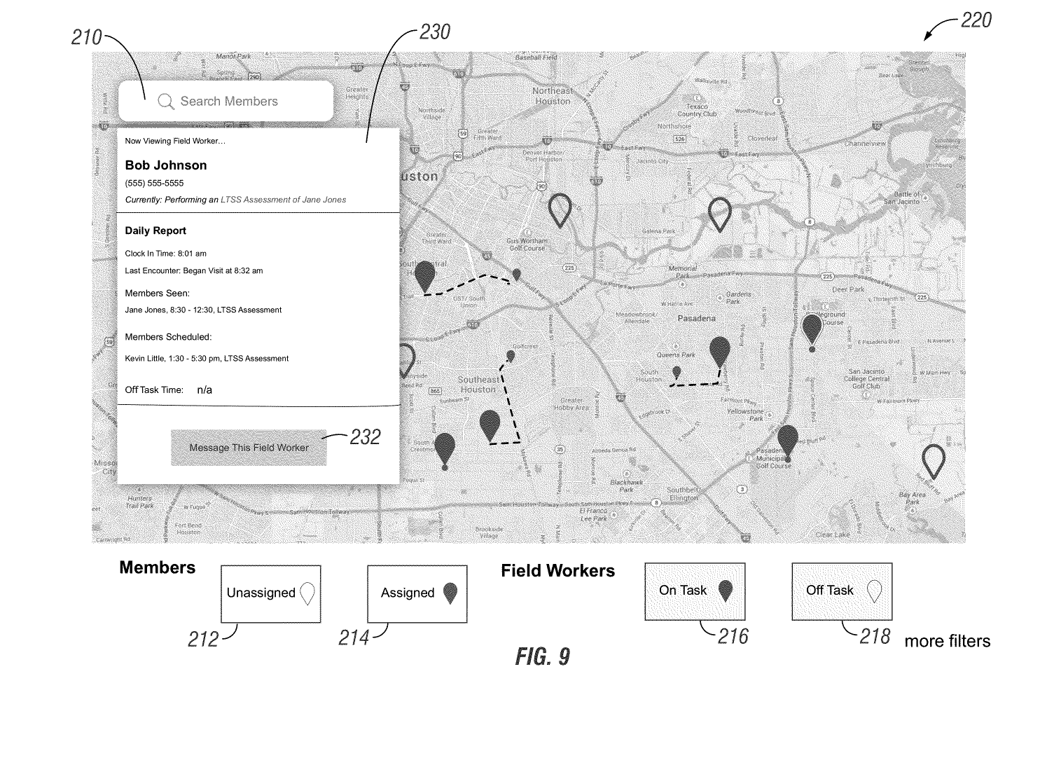

FIG. 9 illustrates the dashboard 220 with a panel 230 displayed. The panel is displayed when a pin or marker associated with a field worker is selected. The panel 230 may overlay the map and provide a daily report for a field worker. As shown in FIG. 9, the field worker is currently on-site. Information presented may include the name of the field worker, the qualification level of the field worker, a phone number for the field worker, status information such as where the field worker currently is or what they are performing. The daily report may include when they started work for the day, information regarding their last encounter, what members have been seen, what members have been scheduled, as well as time spent that is considered off task time, what services were performed by the field worker, or other information. A button 232 is shown which allows the field worker to be messaged.

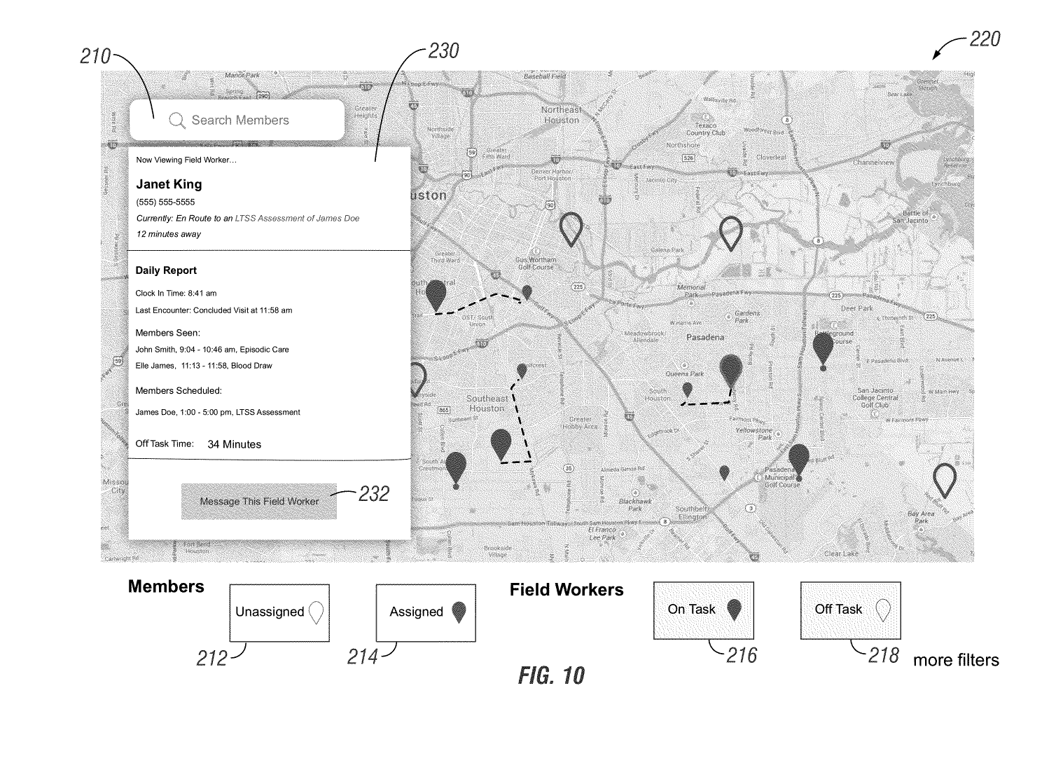

FIG. 10 illustrates the dashboard 220 for a field worker who is en-route. The panel 230 displays status information showing the appointment that the field worker is currently en-route to and an indication of how far away it is to see the member.

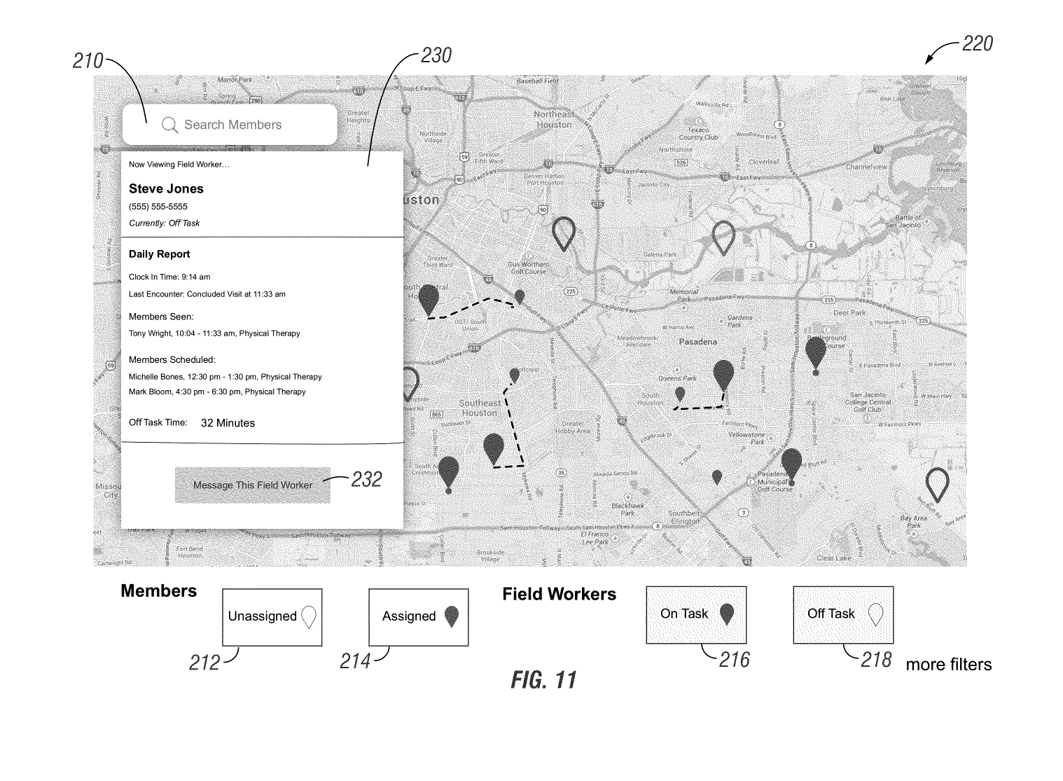

FIG. 11 illustrates the dashboard 220 for a field worker who is currently off-task. The status of the field worker as “Off Task” as well as an off-task time.

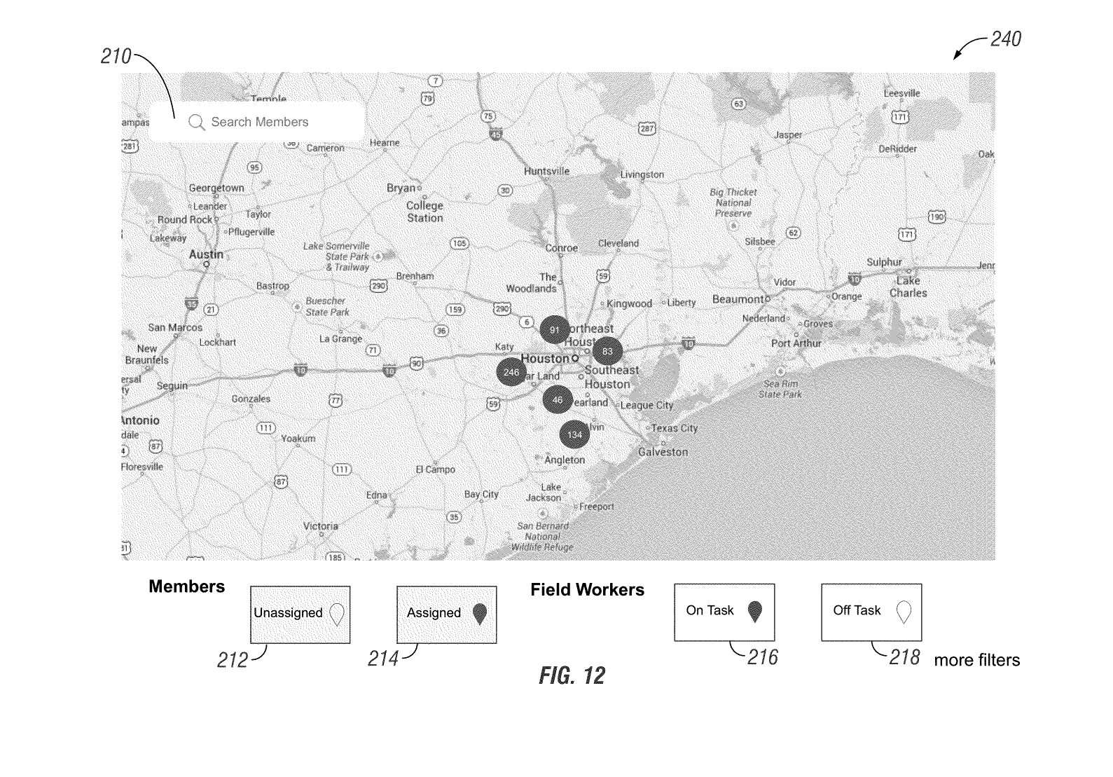

FIG. 12 illustrates a dashboard 240 for viewing members. The dashboard 240 is zoomed out relative to that shown in FIG. 11. With the map zoomed the number of on-duty workers can be seen for a given area based on the numbers provided on the markers.

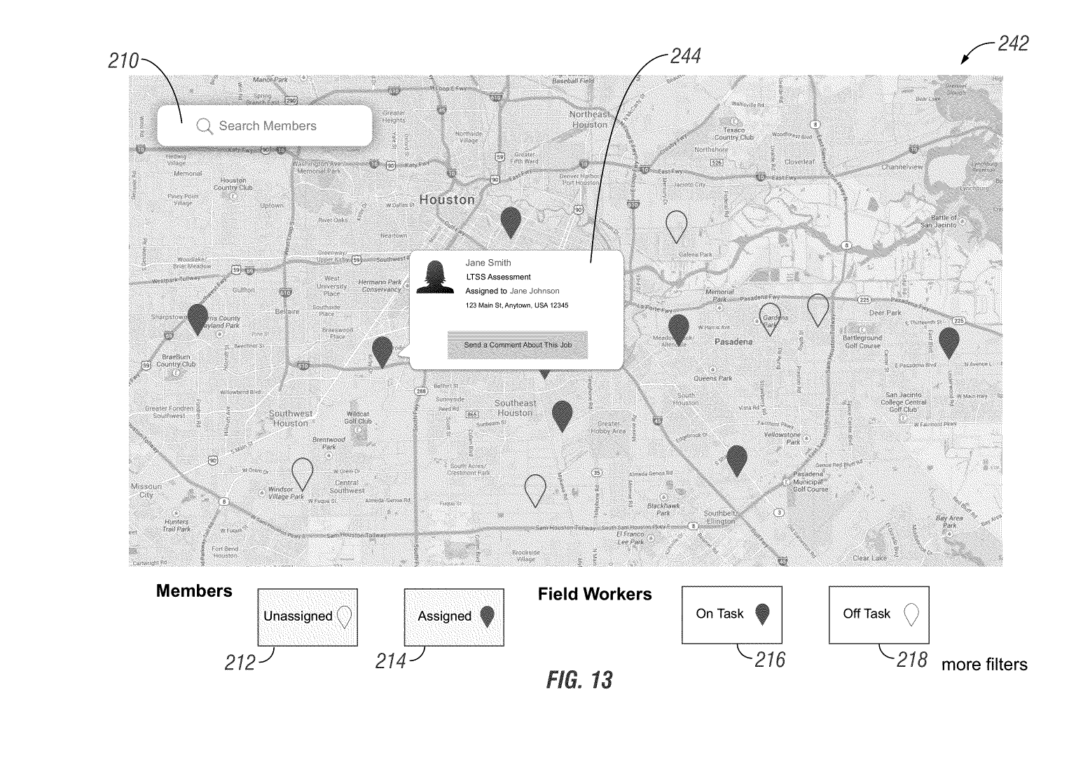

FIG. 13 illustrates a dashboard when viewing an assigned member. A window 244 with information about an assigned member is shown. The information may include a job to be performed for the member, who is to perform the job, and an address for the member. Comments may be sent to the field worker for use when they are present at the job.

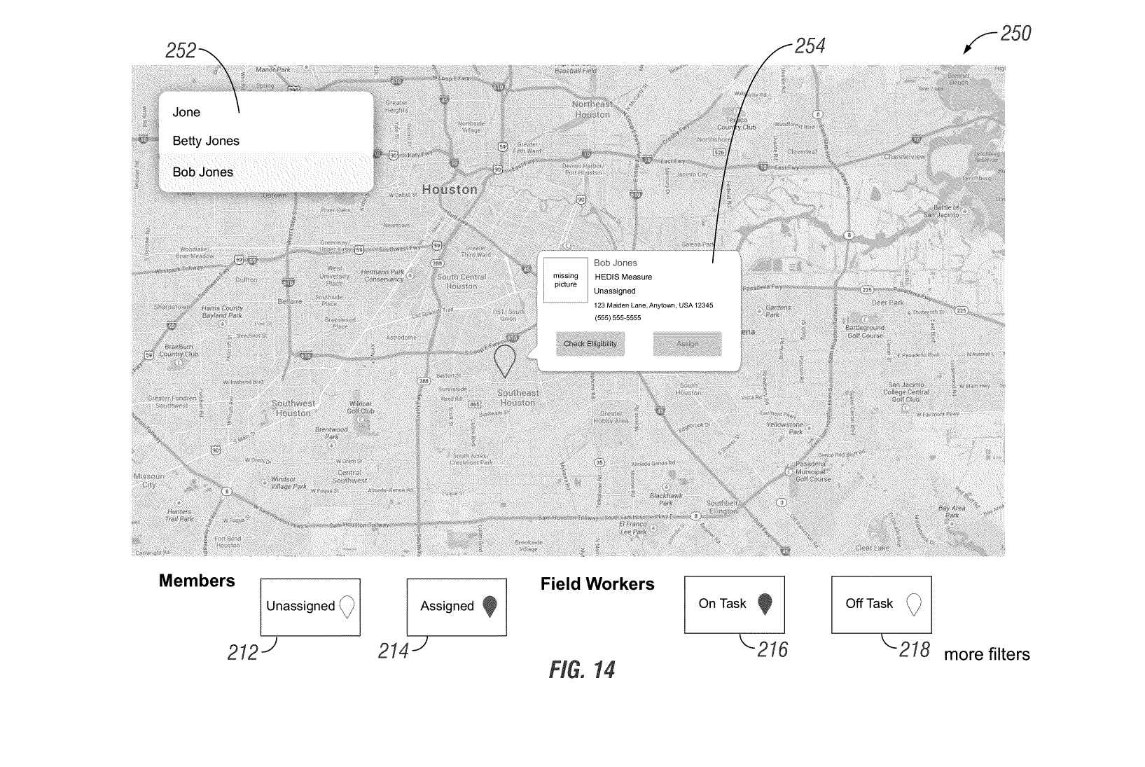

FIG. 14 illustrates a dashboard 250 to illustrate functionality for searching for an unassigned member. In the search box 252 a name may be searched on and then window 254 appears corresponding to the name selected as a result of the search. Buttons for checking eligibility and assigning the member to a field worker are shown. A member cannot be assigned a field worker until their eligibility is checked.

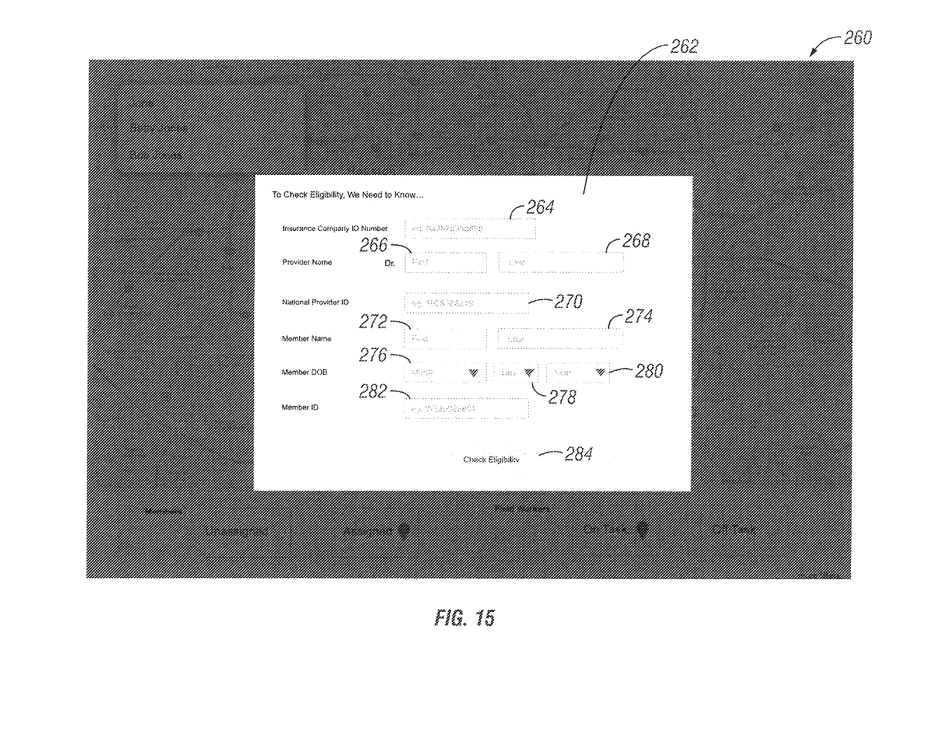

FIG. 15 illustrates the dashboard 250 with a window 262 present for checking eligibility. The window 262 includes form fields for collecting information such as insurance company ID number 264, a provider name (such as first name 266 and last name 268), a national provider ID 270, a member name (such as first name 222 and last name 274), a member date of birth including month 276, day 278, and year 280, and a member ID 282. A button 284 is provided to initiating the eligibility check.

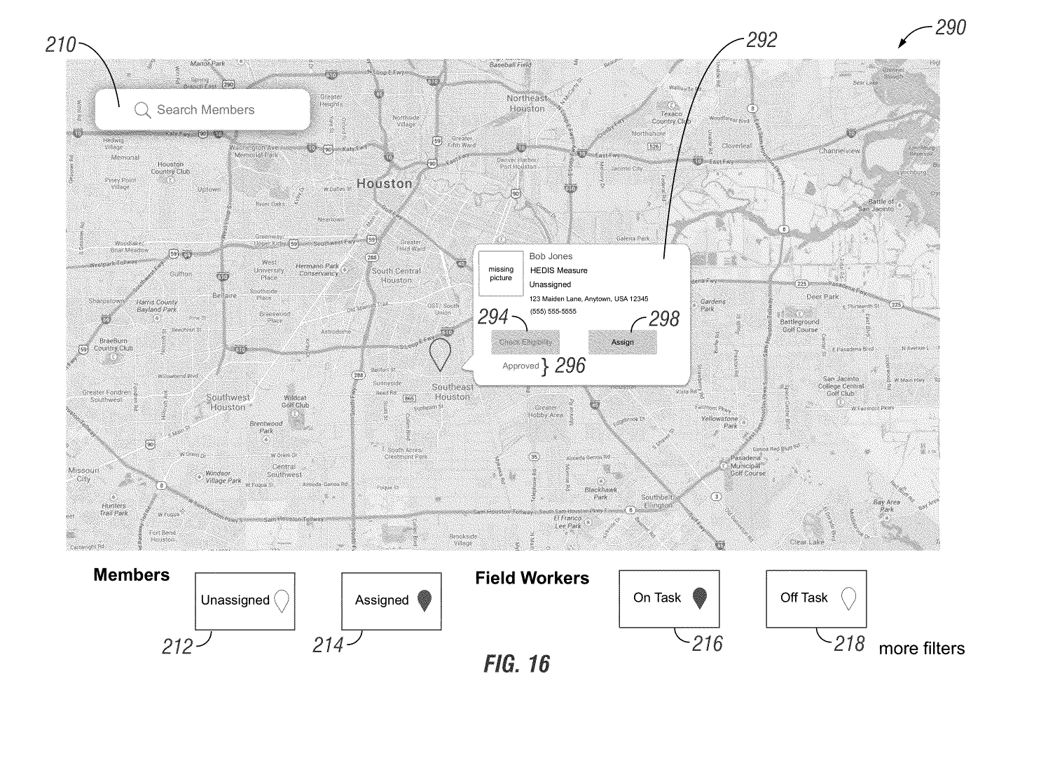

FIG. 16 illustrates a map dashboard 290 after eligibility has been confirmed. Note that in the window 292, the check eligibility button 294 is now disabled and status information 296 indicating that the member has been approved is shown. The assign button 298 is enabled allowing the member to be assigned to a field worker.

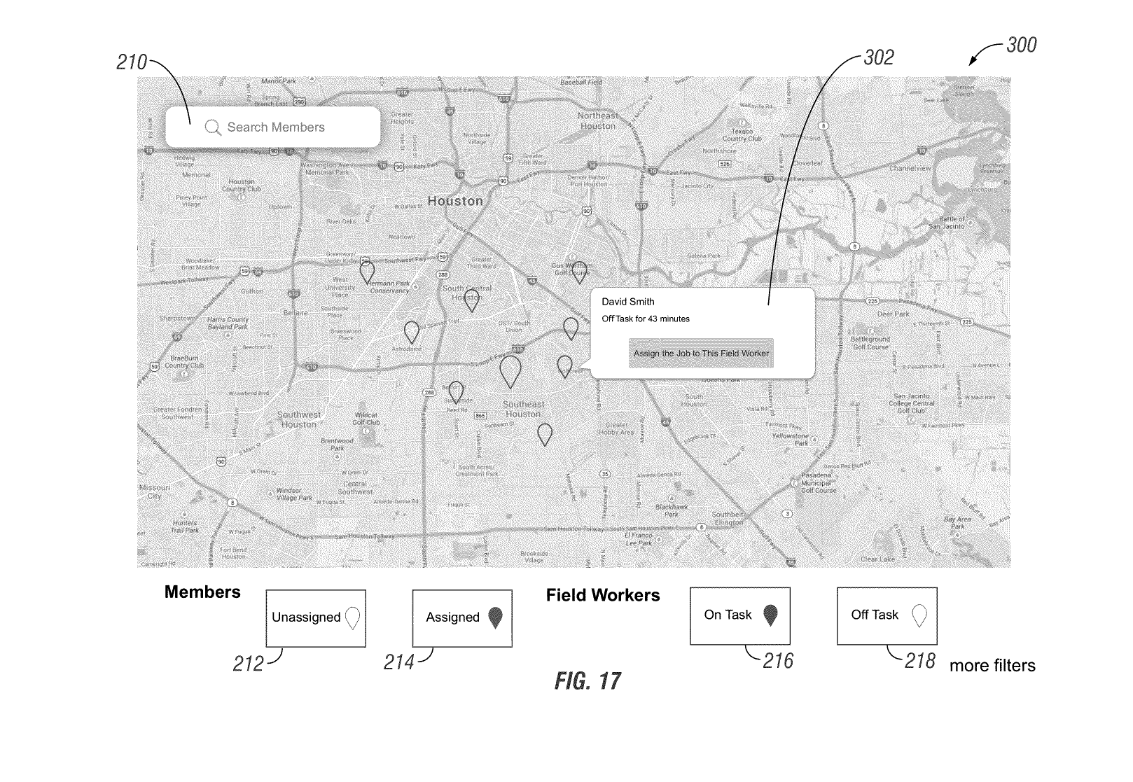

FIG. 17 illustrates a map dashboard 300 for assigning a field worker. A window 302 showing a field worker near the member to whom the field worker is to be assigned is shown. The field worker may then be assigned to the member.

Although various examples of a dashboard have been shown and described and various functions have been described, it is to be understood that numerous variations, options, and alternatives are contemplated for its implementation.

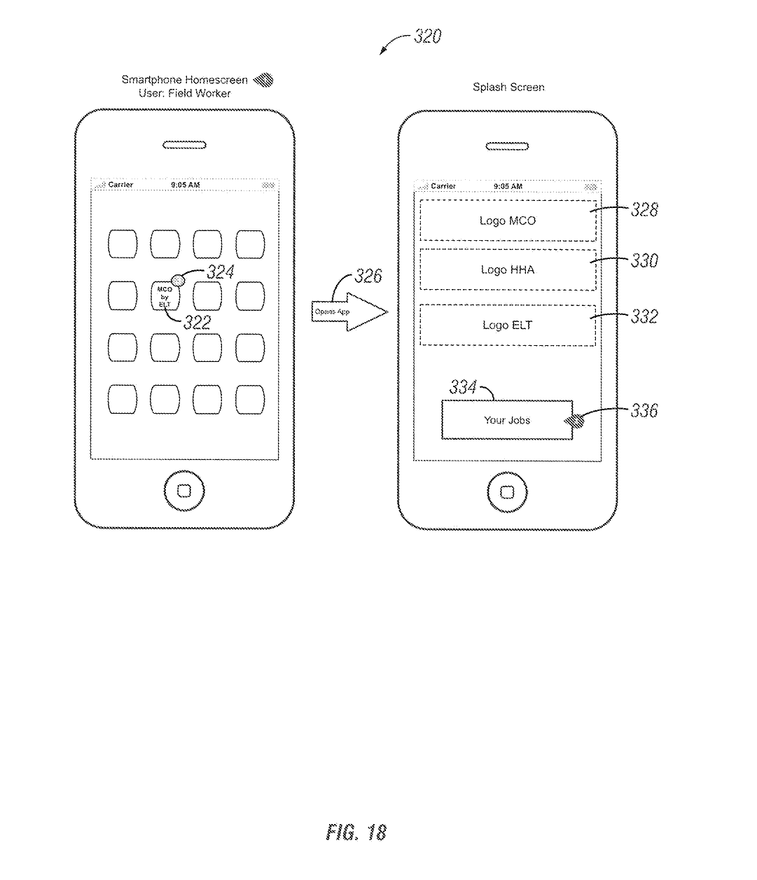

FIGS. 18-23 illustrate various examples of a user interface for use by a field worker. As shown in FIG. 18, a mobile device is shown with app icons including an icon 322. A notification number 324 is displayed on the icon 322. Thus an administrator using a dashboard can create jobs that are pushed to the mobile device. The field worker may then open the app 326 and may be presented with a splash screen such as with a logo for an MCO 328, a logo for an HHA, and a logo for the ELT 332. A button 334 may be displayed allowing a user to view their jobs and advance to a next screen.

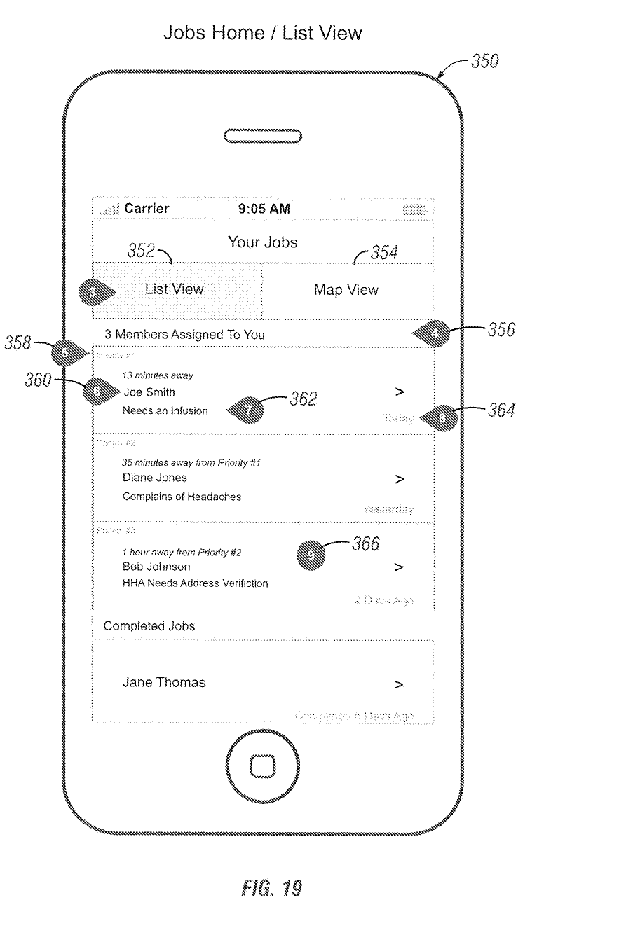

As shown in FIG. 19 a jobs home/list view is provided. The mobile device 350 provides a user interface, allows a user to select between a list view 352 and a map view 354. The jobs may be segmented for display purposes in any number of ways so as to enhance efficiency of the field worker. One way to segment the jobs is by displaying members 356 assigned to the field worker. The jobs may be ordered by the prioritization 358 that an administrator assigns through the dashboard, proximity, or otherwise. Job information may include the name 360 of the member. Where the jobs are prioritized the jobs may be displayed in order of priority or flags, stars, or other visual references may be used to indicate priority. In addition, the distance to nearby jobs may also be shown. Where jobs are close by the current location an indication that the job is close by may also be provided. In addition a short description 362 of the jobs may be included. Also, an indication of when the job assignment was made 364 may also be displayed. Jobs that are displayed may be opened such as by tapping on a particular job. Thus, tapping on job 366 would then open the job.

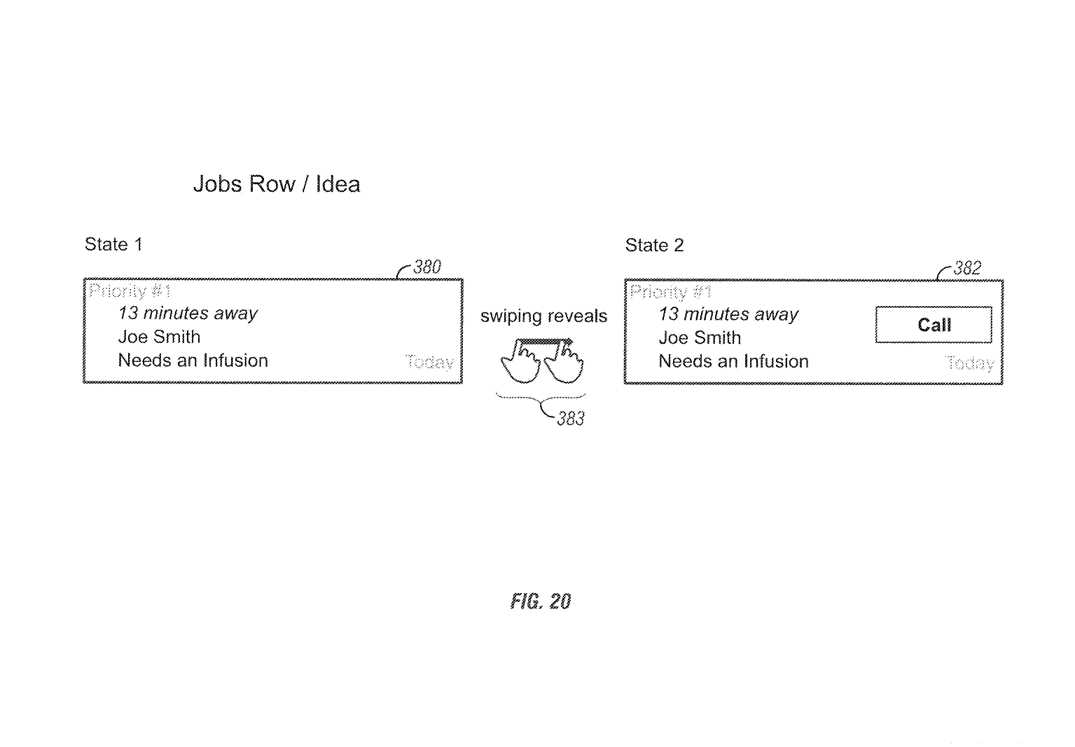

FIG. 20 illustrates one example of additional functionality that may be provided to the app. In FIG. 20 a job row 380 is shown. A user may swipe 383 (instead of tap) the job row 380 to reveal additional information or functionality as shown in job row 382. The additional information or functionality may be a call button in order to initiate a phone call to the member, although other additional functionality is contemplated. Note that when phone calls are initiated in this manner the application can track that a phone call was made. Thus, a record may be stored indicating that the phone call to the member was made, when it was made, the duration of the phone call, the location of the user when the phone call was made, or information about the phone call.

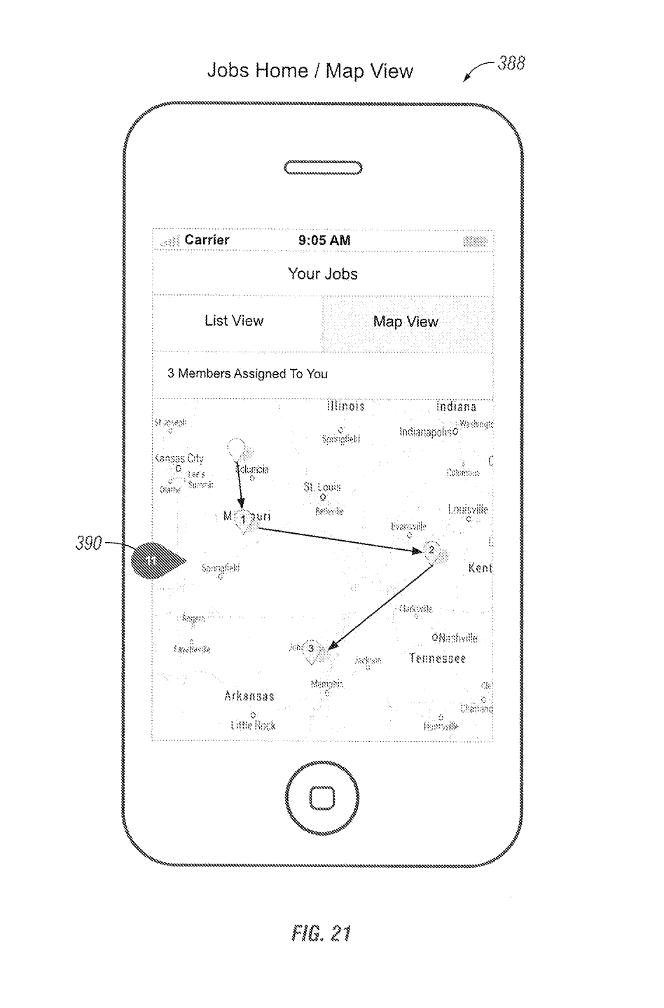

FIG. 21 illustrates a mobile device 388 showing the map view. The map view may show a map 390 with the location of the field worker and the addresses of each member. Routes between different sites that take into consideration pre-established priorities may also be provided.

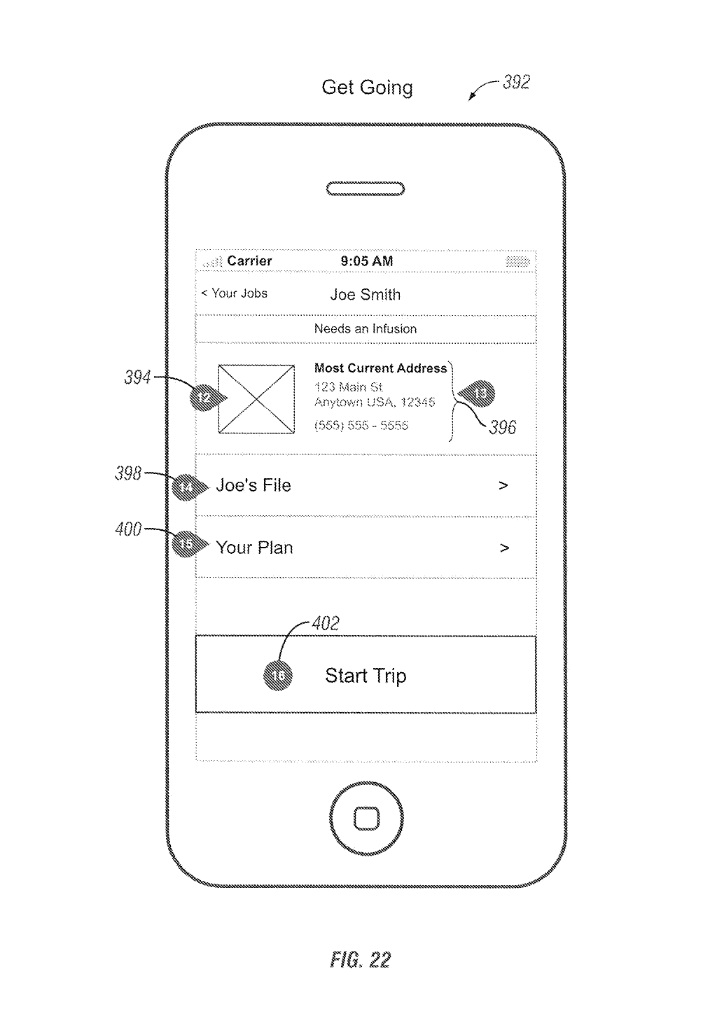

FIG. 22 illustrates a “Get Going” screen display for a mobile device 392. The name of a member associated with a job may be displayed. If there is a photo 394 of the member available it may be displayed. Location/contact information 396 such an address and phone number may also be displayed. History 398 may be displayed such as medical history or alternatively alternate or old addresses and contact information may be accessed. The plan 400 for the member is also provided. The plan may include the checklist or protocol of the steps that a field worker will take in order to care for the member when the field worker arrives at the location of the client. A “Start Trip” button is also displayed, which guides the field worker to the member is also provided such a through opening a live map. Real-time GPS data regarding the field worker's location may then be sent back to the dashboard. When the field worker arrives a screen may open immediately to the plan of the member being visited.

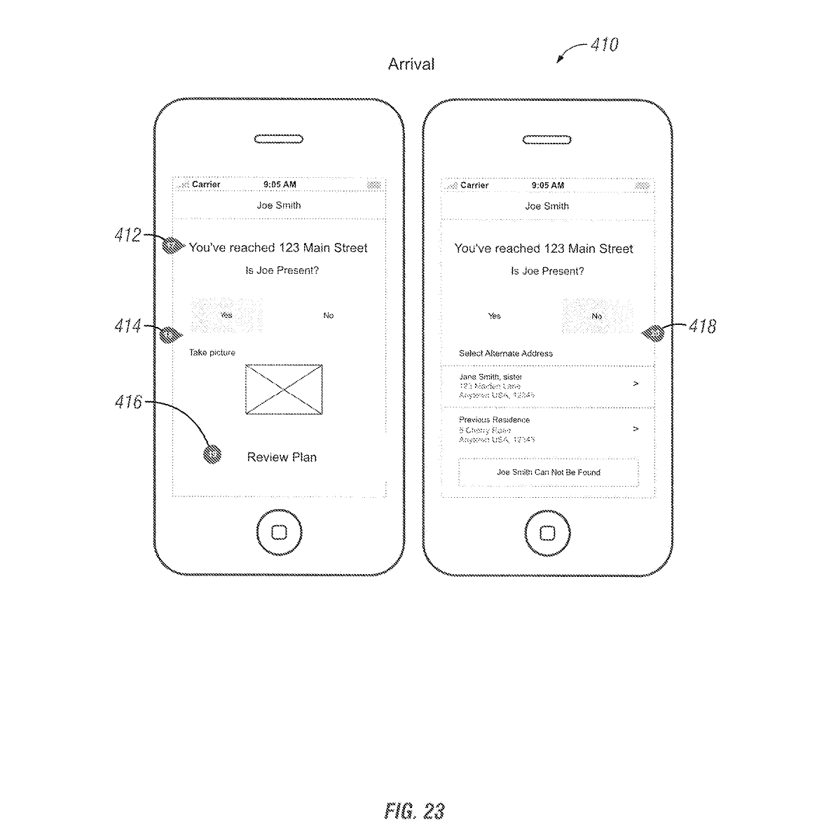

FIG. 23 illustrates screen displays on a mobile device 410, which are associated with arrival. A notification 412 may be shown to indicate to the field worker that they have arrived at an address associated with a member. The field worker is presented with the a question regarding whether or not the member is present and the field worker can then select “Yes” or “No.” When the member is present, the field worker can be prompted to take a picture of the location. The field worker can then select to review the plan. If the field worker is not present then a list of alternative addresses can be presented.

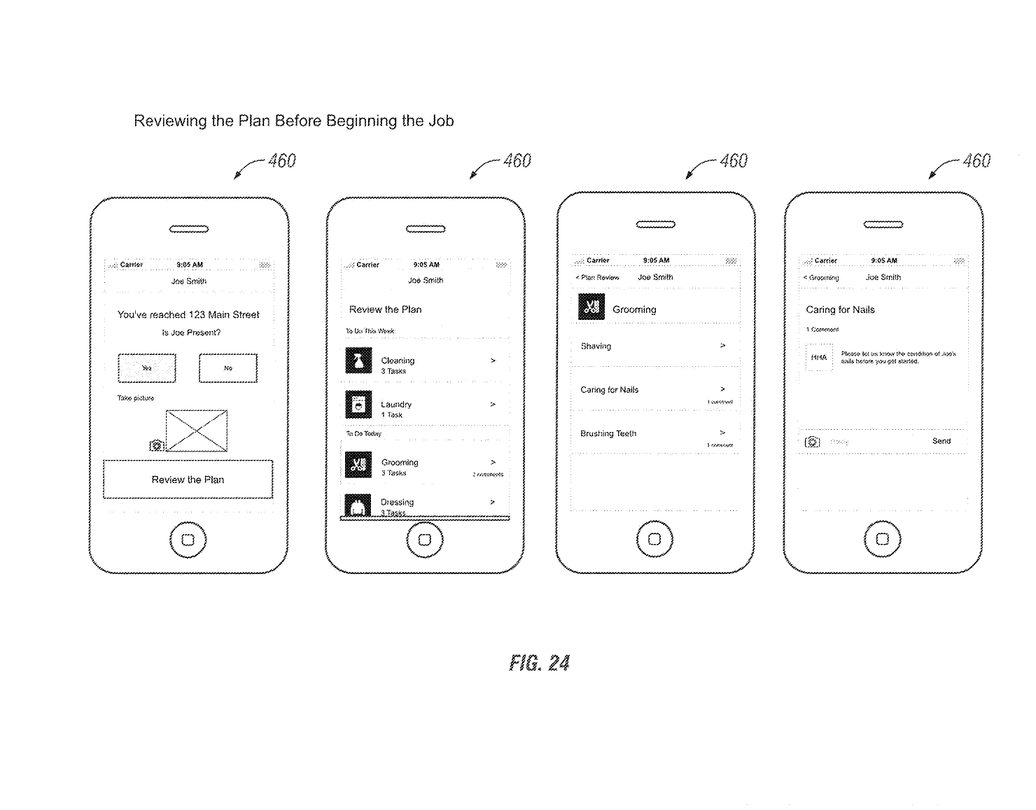

FIG. 24 illustrates various screen displays relating to reviewing a plan before beginning a job. Once a field worker selects yes as shown in screen display 430, in screen display 440 the field worker can review the plan, which can be organized in various ways such as by frequency of task and type of tasks. Screen display 450 shows on example of tasks organized by type showing multiple grooming tasks including shaving, caring for nails, and brushing teeth. Screen display 460 shows a caring for nails task with a comment from an administrator to report on the condition of the member's nails. This can be done immediately and sent along with a photo.

Although shown in the context of specific tasks for taking care of the member, it is to be understood that the tasks may be associated with any number of skill levels and the same methodology may be used regardless of the specific tasks, the level of skill of the field worker and regardless of whether the field worker is performing non-skilled services or highly skilled medical services. The tasks may directly correspond to tasks assigned via a state or other governmental entity or via MCO allotted services. The tasks are specific to member needs for each visit.

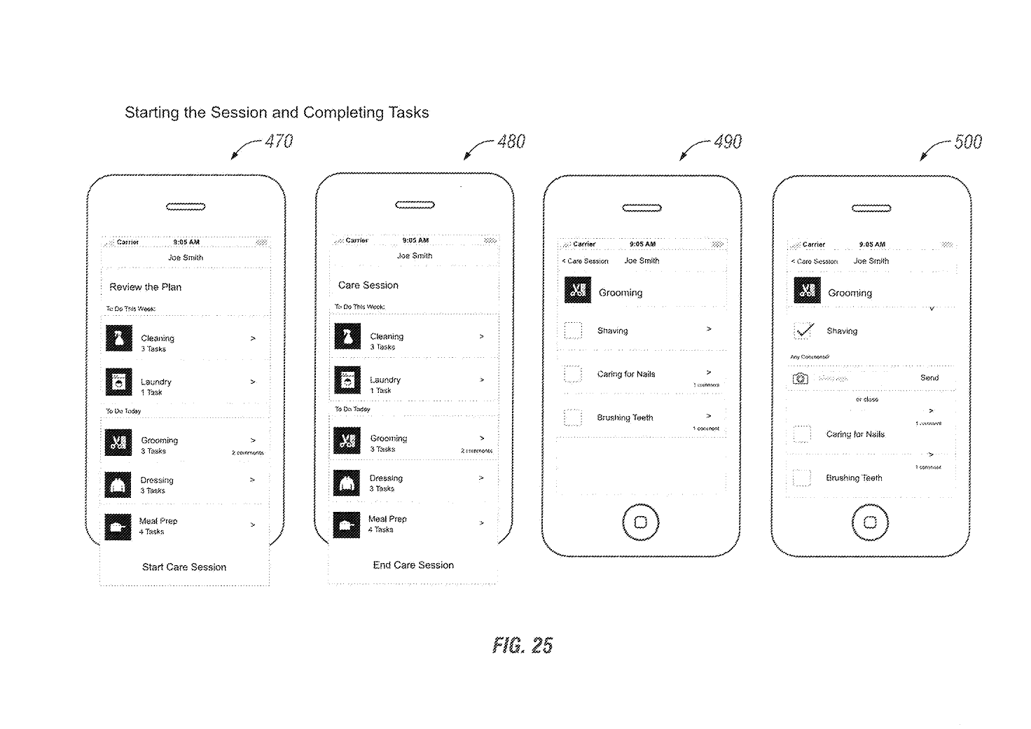

FIG. 25 illustrates various screen displays relating to starting a session with a member and completing tasks. Screen display 470 illustrates tasks organized by type and frequency. A field worker can select to start the care session. Screen display illustrates that when the care session is complete, the field worker can select to end the care session. When the care session ends a timer may end so that the amount of time for the care session may be determined and recorded. Communications to the MCO, HHA, or other administrator may be performed to report on what happed on the visits, the time spent on the visit relative to the time scheduled for the visit, or other information related to the visit. Screen display 490 illustrates a subset of tasks, in this case for grooming. Screen display 500 illustrates the same subset of tasks, but this time indicating that one of the tasks is complete and also allowing a photo and/or message to be sent.

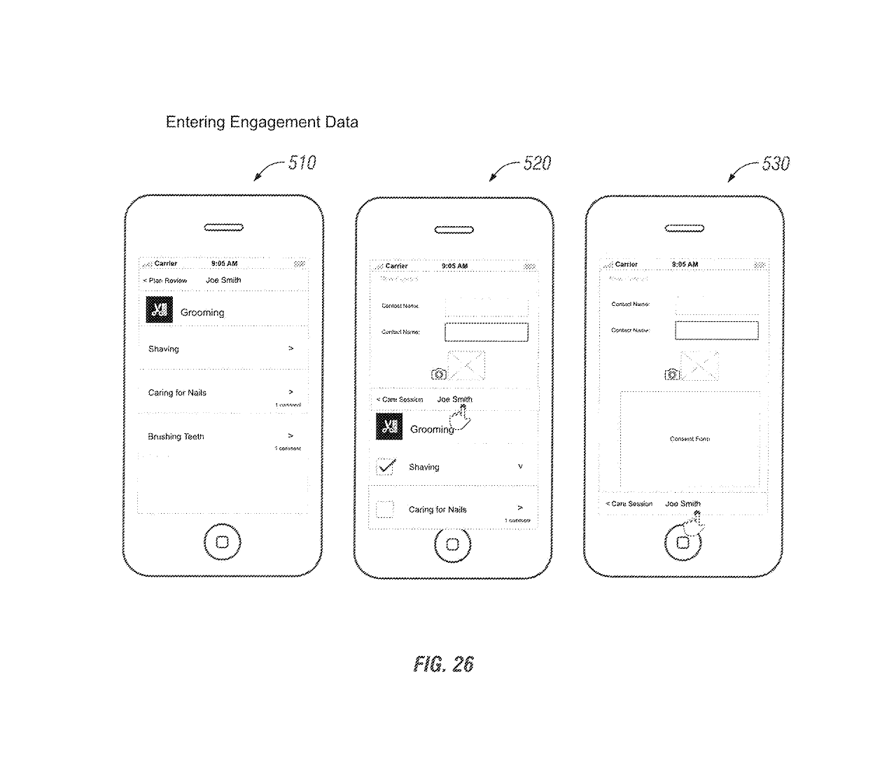

FIG. 26 illustrates various screen displays relating to entering engagement data. As shown in screen display 510, grooming tasks as a part of a plan for a member are shown. In screen display 520, a new contact can be entered which is associated with the member. In screen display 530, the new contact information is shown along with a consent form. Thus, consent forms can be electronically signed through the system.

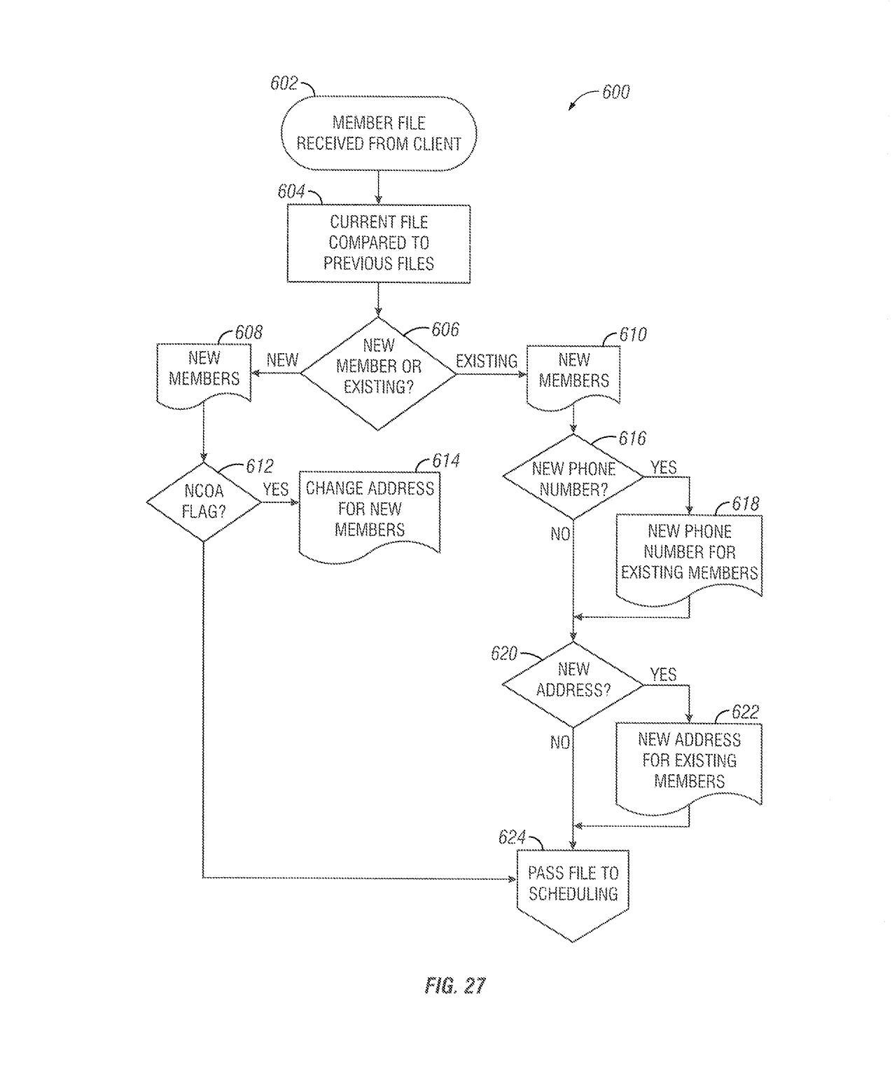

FIG. 27 through FIG. 31 further illustrates various processes that may be performed. FIG. 27 illustrates a flow diagram showing initial processing of a member file. The process 600 begins in step 602 when a member file is received from a client. The member file includes information about individuals receiving health care benefits. In step 604, the current member file is compared to previous files. In step 606 a determination is made as to whether each member within the member file is a new member or an existing member. If the member is a new member then the new member can be included on a document or report 608 listing new members. Then in step 612 a determination is made as to whether or not there is a change of address. If there is then a document or report 614 may be updated to included changed addresses for new members. If not, then the member file may be passed on for scheduling as shown in step 624. Returning to step 606, if the member is an existing member, then a report or document 610 can be provided, which includes existing members. In step 616 a determination is made as to whether the phone number is a new phone number. If it is, then a report or document 618 can be updated for new phone numbers for existing members. In step 620 a determination is made as to whether the address is a new address or not. If it is then in step 622 a report or document 622 is updated to include new addresses for existing members. In step 624 the file may be passed to scheduling.

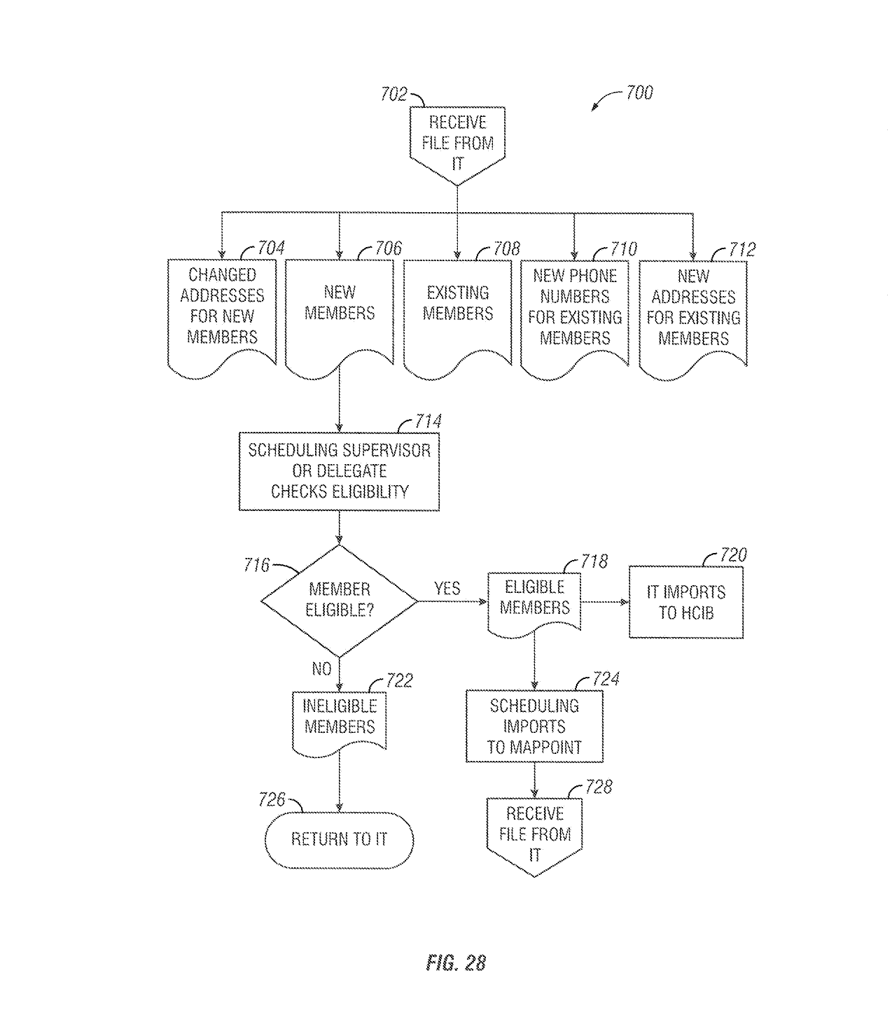

FIG. 28 is a flow diagram illustrating a process 700 for scheduling. In step 702 a file is received. The file may be broken down into multiple parts including a report showing changed addresses for new members 704, new members 706, existing members 708, new phone numbers for existing members 710, and new addresses for existing members 712. In step 714, a scheduling supervisor or their delegate checks the eligibility for benefits for each of the new members. In step 716 a determination is made as to whether a member is eligible. If the member is not, then the member is added to a report or document 722 of ineligible members and in step 726 the process may return an update file. If in step 716 a member is eligible, then a report or document 718 may be updated with the eligible members. In step 724, scheduling may import member information into mapping software or a geographical information system. Then in step 728 a member process can be started. In addition, in step 720 the eligible members may be imported into another software system such as a home care IT solution such as Homecare Homebase (HCHB).

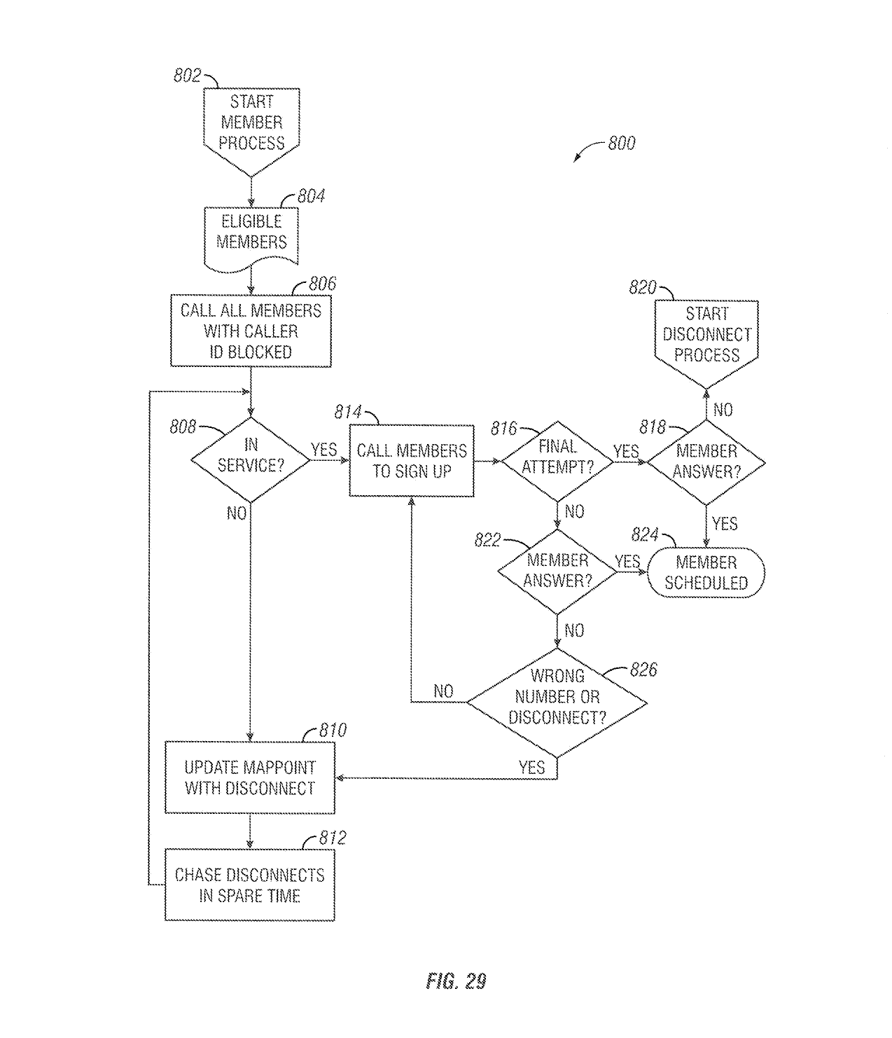

FIG. 29 is a flow diagram illustrating starting a member process 800. In step 802 the process begins. There is a document or report or portion of a file with eligible members 804. In step 806, all members are called with Caller ID blocked. In step 808 a determination is made as to whether the phone number associated with the member is in service. Numbers that ring a minimum number of times, are answered, have voicemail, or refuse blocked call may be hung-up on and considered to be in service. If a number is not considered to be in service, then in step 810 mapping software may be updated to show the disconnect. In step 812, disconnects may be chased or further investigated when time is available. If in step 808 a phone number is considered to be in service, then in step 814 a member is called to sign-up. The member may be told to keep their pets away and told that the nurse or other health care provider will call when in route. In step 816 a determination is made as to whether the attempt to reach the member is a final attempt. It is contemplated that the number of attempts to reach a member may be limited to a maximum number of attempts. If the attempt is the final attempt and in step 818, the member does not answer then in step 820 a disconnect process begins. If on the final attempt, in step 818 the member answers, then in step 824 the member is scheduled. Returning to step 816, if it is not the final attempt and the member answers in step 822, then in step 824 the member is scheduled. If in step 822, the member does not answer then in step 826 a determination is made as to whether the number called is a wrong number or a disconnected number. If not, then the process returns to step 814 to call again. If the number is a wrong number or disconnect, then in step 810 the mapping software may be updated accordingly.

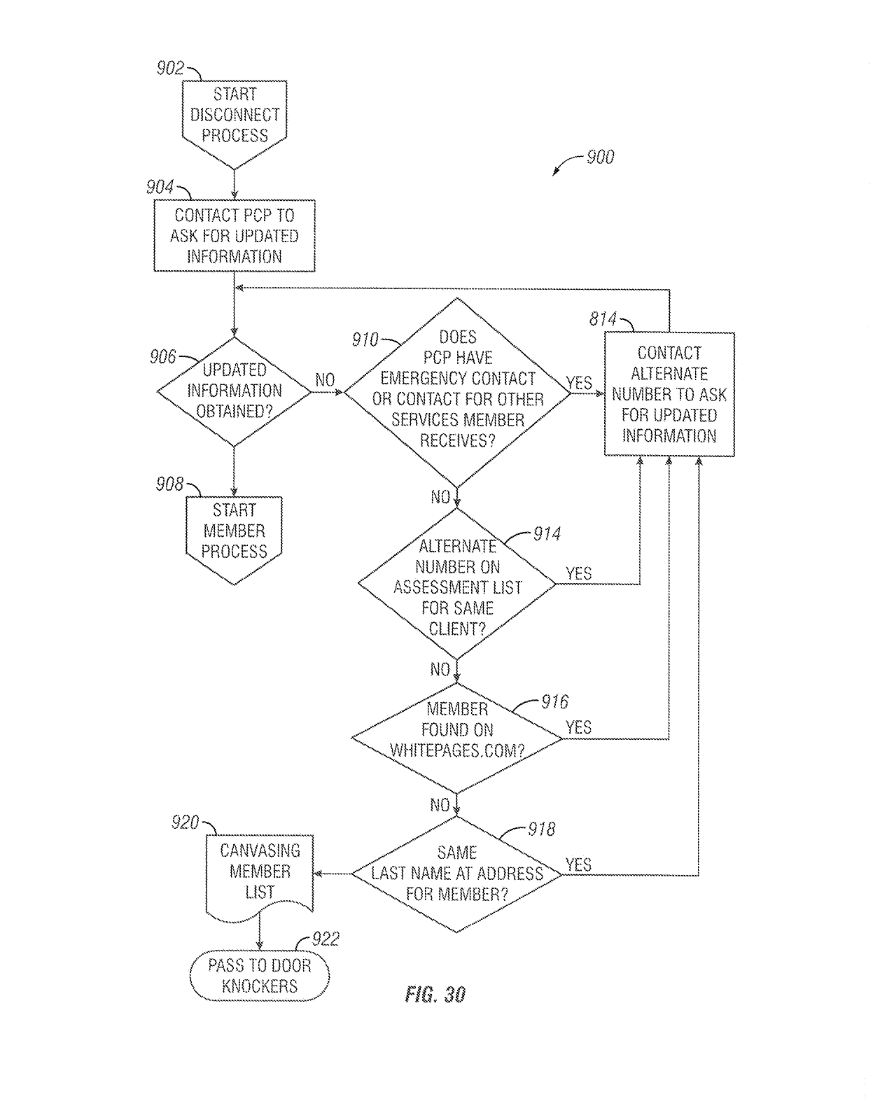

FIG. 30 is a flow diagram illustrating a process 900 for finding members. In step 902, a disconnect process begins. In step 904 a primary care provider (PCP) is contacted and asked to provide updated contact information. There may be notes stored in the system to indicate a practice or clinic associated with the PCP, to whom to speak, when to call, and other information. In step 906 a determination is made as to whether updated information is obtained. If it is, then in step 908 the member process may be started. If not, then in step 910 a determination is made as to whether the PCP has an emergency contact or contact information for other services that the member receives. If this information is available, then in step 912, the alternate number may be used to ask for updated information. If this information is not available, then in step 914 a determination is made as to whether there is an alternate number on an assessment list for the same client. If there is, then in step 912, the alternate number may be called to ask for updated information. If in step 914, there is no alternate number on the assessment list, then in step 916, a determination is made as to whether the member can be found through an online database such as whitepages.com. If an alternate number is found, then in step 912 the alternative number is used. If not, then in step 918 a determination is made as to whether there is a same last name at the same address for the member. If there is, then in step 912, the alternative information is used to contact and ask for updated information. If note, then the member may be added to the canvassing member list 920. The list may include information such as full name, age, gender, address, incorrect phone number, PCP name. Once the list has sufficiently grown within a particular area, people may be sent out to knock on doors to attempt to locate members. Thus, in step 922, the canvassing member list 920 is passed to door knockers.

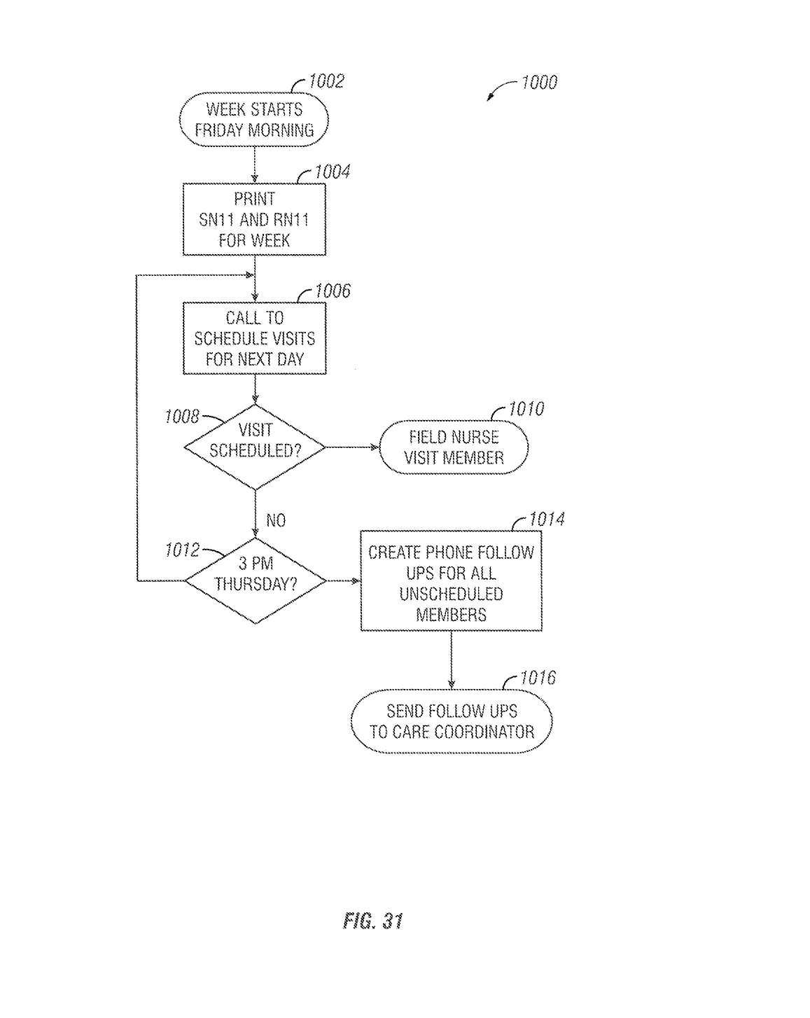

FIG. 31 is a flow diagram illustrating a process 1000 for scheduling visits. In step 1002 a week starts on a Friday morning. In step 1004 various types of visits to be performed by an organization within the next week are printed or otherwise output. In step 1006 calls are made to schedule visits for the next day. Preferably scheduling occurs only one day in advance in order to keep no shows and cancellations minimized. In step 1008 a determination is made as to whether the visits are scheduled. If there are then in step 1010 a field nurse or other appropriate personal visit the member. If not, then in step 1012 the process returns to step 1006 as long as a certain time has not been reached such as 3 PM on the following Thursday, in this example. If the time period in step 1012 has been reached, then in step 1014 then phone follow ups may be made for all unscheduled members. In step 1016 follow ups may be sent to care coordination.

Thus, as shown and described with respect to FIGS. 27-31, various processes may be followed to process a member list, determine eligibility for members, find members, and schedule visits.

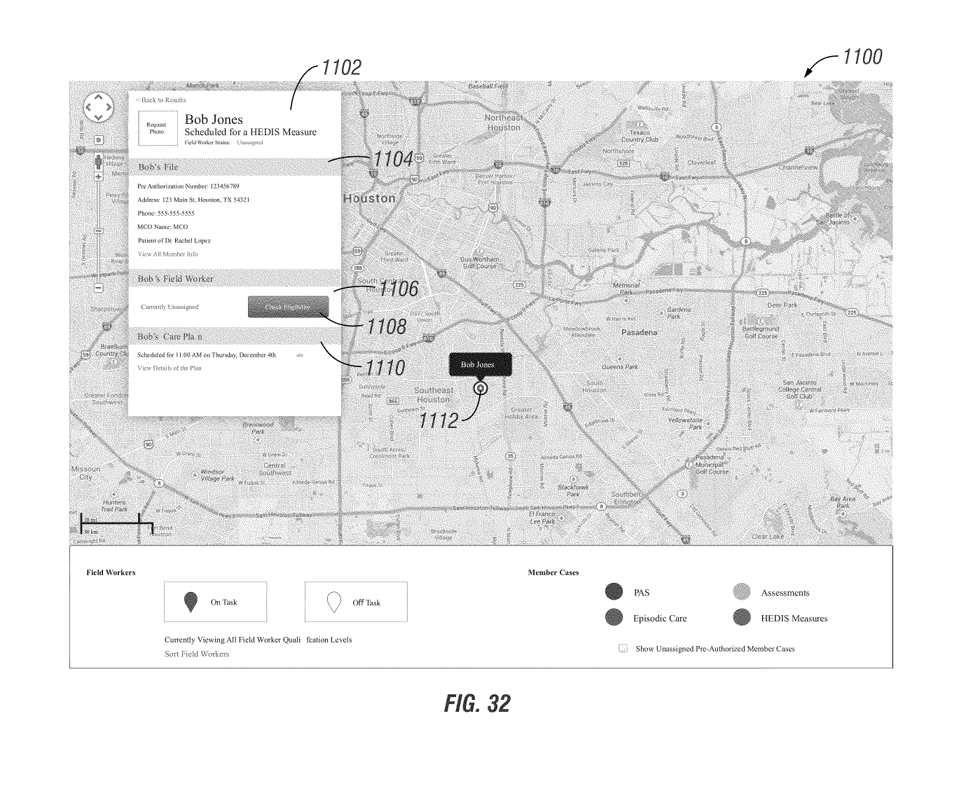

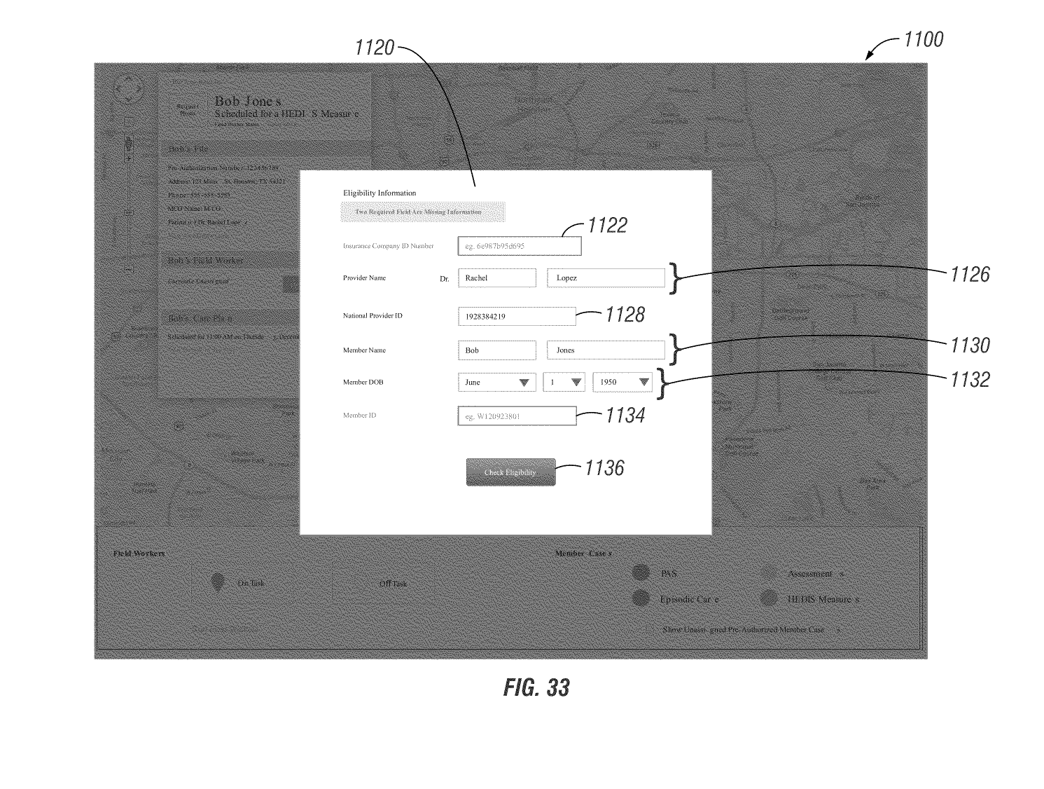

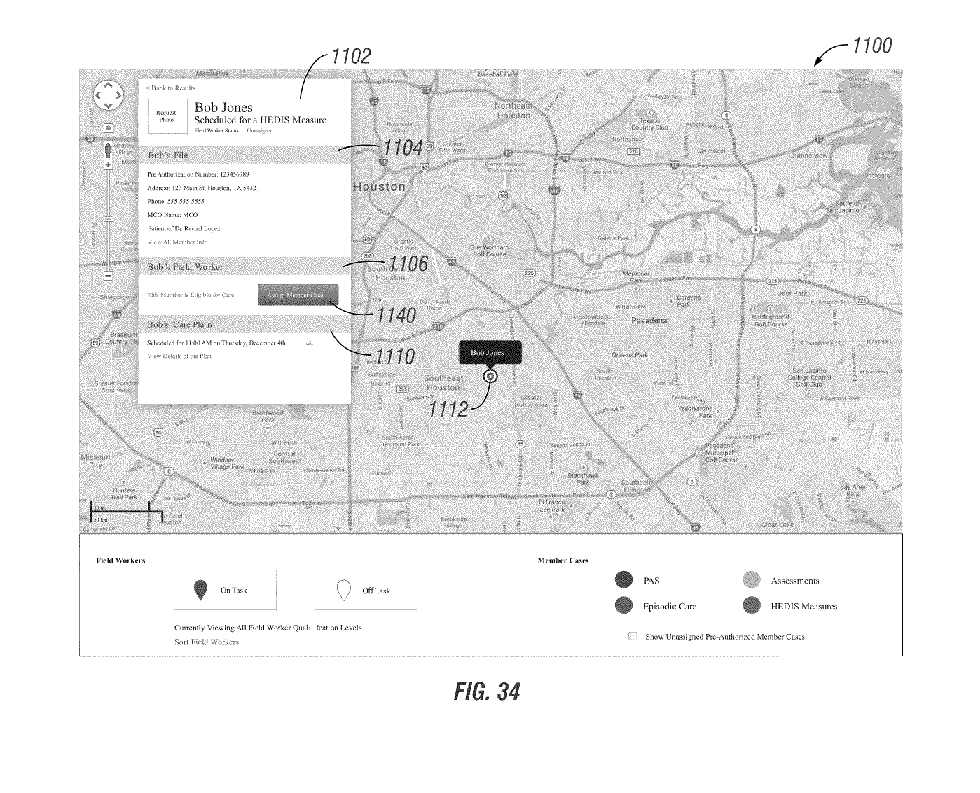

FIG. 32 through FIG. 34 illustrates another example of checking for eligibility of a member for health care services. In FIG. 32, a screen display 1100 is shown. A map point 1112 shows location of the member on a map. A window 1102 is also shown for the member. Information on the member's file 1104 is shown as well as for the member's health plan 1110. Information for the member's field worker 1106 is also shown. Currently there is no fieldworker assigned and a “Check Eligibility” button 1108 is provided. Before a fieldworker can be assigned eligibility must be confirmed. FIG. 33 illustrates an eligibility information window 1120 where an insurance company ID number 1122 may be entered as well as a provider name 1126, a national provided ID 1128, a member name 1130, a member DOB 1132, and a member ID 1134. A check eligibility button 1136 is then shown. Once the check eligibility button 1136 is selected, the system connects with appropriate databases to determine the eligibility of the member. Such a feature is advantageous as it prevents benefits to be provided to members who are not eligible to receive the benefits. FIG. 34 illustrates the same screen display 1100 after eligibility has been checked. Note that there is now an “Assign Member Care” button 1140 present because the member has been verified as being eligible for care.

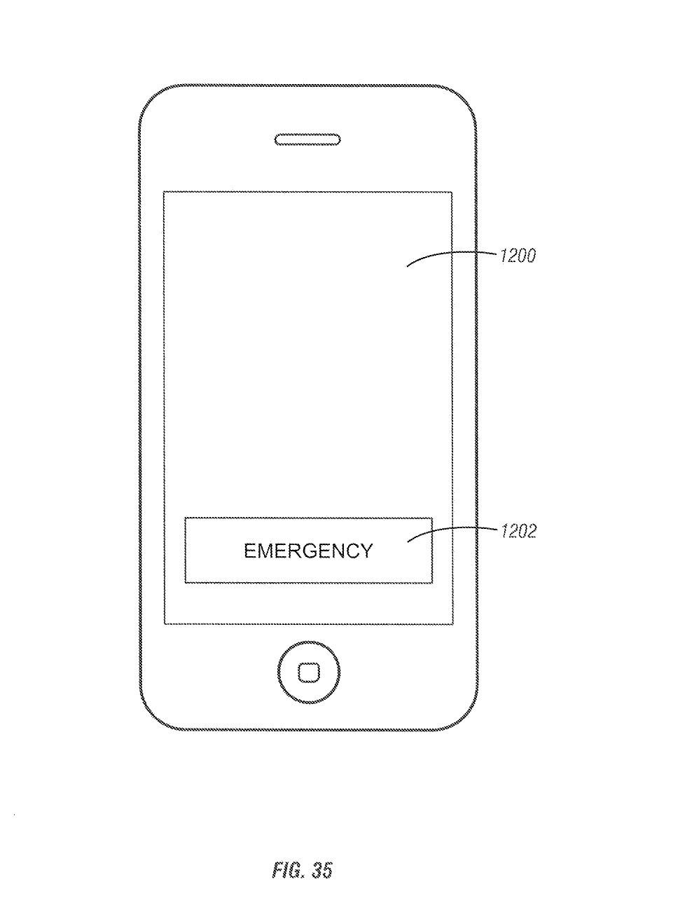

FIG. 35 illustrates an emergency panic button in a mobile app operating on a mobile device. A screen display 1200 is shown that includes an emergency panic button 1202. It is contemplated that the mobile app may automatically provide for showing the emergency panic button 1202 when a user arrives at a work site or leaves a work site based on their location as determined by GPS, their indication that they are arriving or leaving, or otherwise. The emergency panic button 1202 may be integrated into a screen display that contains additional information.

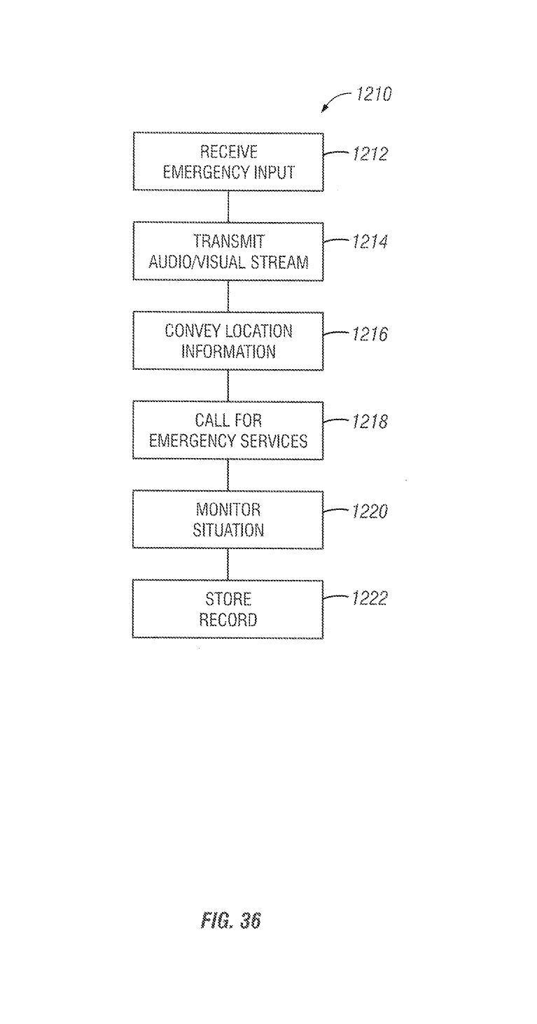

If the worker is in a dangerous situation or requires assistance, the worker can select the emergency panic button 1202 or this functionality can be otherwise initiated. FIG. 36 is a flow chart showing a method 1210 associated with emergency functionality. In step 1212 an emergency input (such as pressing of the emergency panic button) is received from a user. In step 1214 audio/visual information such as a video stream may be communicated from the device back to an operations center or dispatch or remote location using the dashboard software application. Simultaneously, or otherwise, location information 1216 may be communicated back to operations center or dispatch. In step 1218, emergency services may be called. The audio/visual information may be monitored remotely at the operations center or dispatch or a remote location using the dashboard software application. An individual at the operations center or dispatch may also be joined on the call to emergency services as well as audio from the user. In step 222 the audio/video stream and location information may be stored as a record. In addition, the call with emergency services may also be stored. In addition to storing a record at a remote location, it is contemplated that this information may also be stored on the mobile device itself. In this manner, not only is an audio and video record of an emergency situation being created, but location information can be quickly communicated to emergency services with the assistances of the operations center or dispatch. This increases the safety for workers, decreases response time, and creates an evidentiary record of the situation.

It should be understand, although the emergency panic button functionality can be especially useful for health workers or others who provide benefits, this functionality is not limited to on-site health care and can be used in any number of different situations for any number of types of individuals, especially those who are in situations that may result in the need for emergency services including medical, police, fire, rescue, and other emergency services.

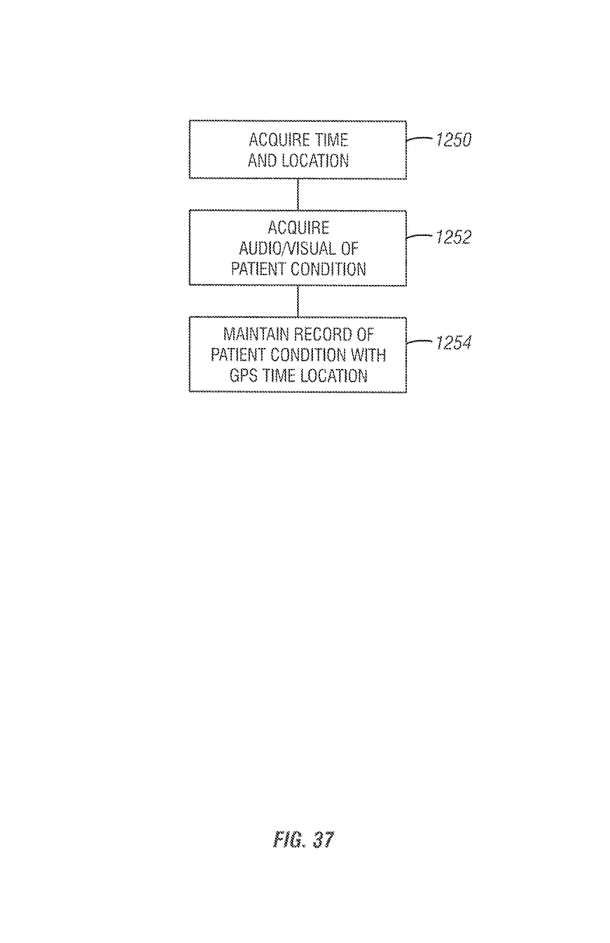

FIG. 37 is a flow chart associated with documenting patient condition at arrival time. As previously explained, audio and visual information regarding members may be documented and recorded for a variety of reasons. This audio and visual information may be associated with time and location information (such as provided by GPS). Additional functionality that the mobile app may provide is to tie patient current condition to the arrival time of a caregiver. Thus, the arrival time of the care giver may be tracked and photos or video recording of a patient's condition may be recorded along with the time. One of the advantages of recording this information and these types of relationships is mitigation of risk from wrongful claims of abuse or neglect as this evidence can be used to establish the condition of a patient at the time of arrival of a caregiver. Thus, in step 1250 the time and location associated with arrival may be determined. In step 1252 audio/visual information of the patient's condition may be recorded. In step 1254 a record of the patient's condition with GPS time and location may be maintained as well as information regarding the time of arrival.

Therefore various methods and systems for improving health care quality and/or reducing costs of providing health benefits have been shown and described. It is to be understood that numerous options, variations, and alternatives are contemplated. These include variations driven by the specific job functions performed by an individual delivering services, variations in the user interface of the mobile app and the functionality of the mobile app, variations in the user interface of the dashboard software application and the functionality of the dashboard software application, variations in the analysis and reporting performed, variations in the communications between the database and other data sources or data recipients, and other variations as may be apparent to one skilled in the art having the benefit of this disclosure.

What is claimed is:

1. A method to improve health care quality and/or reduce costs of providing health benefits, the method comprising:
collecting data about individuals receiving the health benefits through engagement with the individuals to collect data using an app executing on a mobile device;
collecting data regarding logistics for deliver) of the health benefits using the app executing on the mobile device;
managing the delivery of the health benefits from a remote location using a dashboard software application in real-time communication with the app executing on the mobile device.

2. The method of claim 1 wherein the managing the delivery of the health benefits is provided using a dashboard.

3. The method of claim 2 wherein the dashboard includes a map view wherein the map view shows locations for the individuals receiving the health benefits.

4. The method of claim 3 wherein the map view further shows locations for field workers providing services to the individuals receiving the health benefits.

5. The method of claim 1 wherein the app executing on the mobile device provides a user interface to field workers wherein the user interface includes a plan of care to be performed during a visit with the individual receiving the health benefits.

6. The method of claim 5 wherein the plan of care is organized into a plurality of tasks to be performed during the visit with the individual receiving the health benefits.

7. The method of claim 6 wherein the user interface further provides for collecting audio and/or video documentation of performance of the plurality of tasks within the plan of care.

8. The method of claim 1 wherein the dashboard software application provides for creating jobs to be performed for the delivery of the health benefits and wherein the jobs to be performed are communicated to the app executing on the mobile device.

9. The method of claim 8 wherein the dashboard software application provides for prioritizing the jobs to be performed.

10. The method of claim 9 wherein the app provides for receiving updates from the dashboard software application.

11. The method of claim 1 wherein the app is configured to display alternative locations for the individuals receiving the health benefits.

12. The method of claim 1 further comprising performing an analysis using the data about the individuals receiving the health benefits and the data regarding the logistics for the delivery of the health benefits.

13. The method of claim 12 further comprising reporting results of the analysis.

14. The method of claim 1 further comprising storing in a database the data about the individuals receiving the health benefits collected using the app executing on the mobile device and the data regarding the logistics for the delivery of the health benefits collected using the app executing on the mobile device.

15. The method of claim 14 further comprising collecting additional information about the individuals receiving the health benefits and storing the additional information in the database.

16. The method of claim 15 further comprising making available the data about the individuals receiving the health benefits collected using the app executing on the mobile device, the data regarding the logistics for the delivery of the health benefits collected using the app executing on the mobile device, and the additional information about the individuals receiving the health benefits.

17. The method of claim 15 wherein the additional information includes electronic health records.

18. The method of claim 15 wherein the additional information includes information from government databases.

19. The method of claim 14 further comprising storing claims data for the individuals receiving the health benefits in the database.

20. The method of claim 19 further comprising performing an analysis using the data about the individuals receiving the health benefits, the data regarding the logistics for the delivery of the health benefits, and the claims data.

21. A method to improve health care quality and/or reduce costs of providing health benefits, the method comprising:
providing a database stored on a non-transitory computer readable medium;
providing a field worker mobile app for use on a mobile device by field workers, the field worker mobile app having a field worker interface, the field worker interface configured to collect data about interactions with individuals receiving the health benefits, the field worker mobile app further configured to collect data about logistics associated with the delivery of the health benefits, and the field worker mobile app further configured to communicate data collected through the field worker mobile app to the database in real-time;
collecting the data collected through the field worker mobile app at the database;
sending job data to the field worker mobile app; and
collecting logistics data at the database.

22. The method of claim 21 further comprising collecting claims data at the database.

23. The method of claim 22 further comprising analyzing the data collected through the field worker app and the claims data using a computing device operatively connected to the database in order to provide an analysis.

24. The method of claim 23 further comprising generating a report based on the analysis.

25. A system for improving health care quality and/or reducing costs of providing health benefits, the system comprising:
one or more mobile apps for data collection and data access for individuals associated with data collection, wherein each of the mobile apps is tailored to job functions of the individuals associated with the data collection and provides for sending and receiving communications with a server;
a central database storing data collected by the one or more mobile apps and data from additional data sources;
a software application executing on a computing device, the software application configured to access the central database and allow an administrator to send data to the one or more mobile apps in real-time.

26. A method for providing emergency functionality using a mobile app executing on a mobile device, the method comprising:
receiving an input from the user of the mobile device indicative of an emergency situation;
upon receiving the input from the user, streaming audio and/or visual information from the mobile device to a remote location;
sending location information for the mobile device to the remote location;
notifying emergency services of the location for the mobile device.

27. The method of claim 26 further comprising monitoring the audio and/or visual information from the mobile device at the remote location.

28. The method of claim 27 further comprising storing a record of the audio and/or visual information.

29. The method of claim 29 wherein the record of the audio and/or visual information is stored at the remote location.

30. A method to improve health care quality and/or reduce costs of providing health benefits, the method comprising:
collecting data about individuals receiving the health benefits through engagement with the individuals to collect data using an app executing on a mobile device;
collecting data regarding logistics for delivery of the health benefits using the app executing on the mobile device;
managing the delivery of the health benefits from a remote location using a dashboard software application in real-time communication with the app executing on the mobile device;
wherein the data about individuals receiving the health benefits includes audio/visual information documenting conditions of the individuals and time and location information associated with the audio/visual information;
wherein the data regarding logistics includes time of arrival for a care workers providing the benefits;
relating the time of arrival and the audio/visual information and associated time and location information.
